(19) United States
(12) Patent Application Publication
(10) Pub. No.: US 2024/0084689 A1
(43) Pub. Date: Mar. 14, 2024

(54) DRILLING LOSS PREDICTION FRAMEWORK

(71) Applicant: Schlumberger Technology Corporation, Sugar Land, TX (US)

(72) Inventor: Vyom Shrivastava, Lysaker (NO)

(21) Appl. No.: 18/263,229

(22) PCT Filed: Jan. 27, 2022
(86) PCT No.: PCT/US2022/070371

§ 371 Date: Jul. 27, 2023

(30) Foreign Application Priority Data
Jan. 27, 2021 (IN) 202111003701

(51) Int. Cl. E21B 44/00; E21B 21/08; E21B 47/04; G06N 3/0442

(52) U.S. Cl. CPC E21B 44/00; E21B 21/08; E21B 47/04; G06N 3/0442; E21B 2200/22

(57) ABSTRACT

A method can include receiving real-time data for a field operation at a wellsite; predicting a future drilling-related loss event based on at least a portion of the real-time data using a trained recurrent neural network model; and, responsive to the predicting, issuing a signal to equipment at the wellsite.

### RELATED APPLICATION

This application claims priority to and the benefit of India Patent Application No. 202111003701 entitled “Well Event Prediction” filed 27 Jan. 2021, which is incorporated by reference herein.

### BACKGROUND

A resource field can be an accumulation, pool or group of pools of one or more resources (e.g., oil, gas, oil and gas) in a subsurface environment. A resource field can include at least one reservoir. A reservoir may be shaped in a manner that can trap hydrocarbons and may be covered by an impermeable or sealing rock. A bore can be drilled into an environment where the bore (e.g., a borehole) may be utilized to form a well that can be utilized in producing hydrocarbons from a reservoir.

A rig can be a system of components that can be operated to form a bore in an environment, to transport equipment into and out of a bore in an environment, etc. As an example, a rig can include a system that can be used to drill a bore and to acquire information about an environment, about drilling, etc. A resource field may be an onshore field, an offshore field or an on- and offshore field. A rig can include components for performing operations onshore and/or offshore. A rig may be, for example, vessel-based, offshore platform-based, onshore, etc.

Field planning and/or development can occur over one or more phases, which can include an exploration phase that aims to identify and assess an environment (e.g., a prospect, a play, etc.), which may include drilling of one or more bores (e.g., one or more exploratory wells, etc.).

### SUMMARY

A method can include receiving real-time data for a field operation at a wellsite; predicting a future drilling-related loss event based on at least a portion of the real-time data using a trained recurrent neural network model; and, responsive to the predicting, issuing a signal to equipment at the wellsite. A system can include a processor; memory accessible to the processor; processor-executable instructions stored in the memory and executable by the processor to instruct the system to: receive real-time data for a field operation at a wellsite; predict a future drilling-related loss event based on at least a portion of the real-time data using a trained recurrent neural network model; and, responsive to prediction of the future drilling-related loss event, issue a signal to equipment at the wellsite. One or more computer-readable storage media can include computer-executable instructions executable to instruct a computing system to: receive real-time data for a field operation at a wellsite; predict a future drilling-related loss event based on at least a portion of the real-time data using a trained recurrent neural network model; and, responsive to prediction of the future drilling-related loss event, issue a signal to equipment at the wellsite. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a system and examples of equipment in a geologic environment;

FIG. 2 illustrates an example of a system and examples of equipment in a geologic environment;

FIG. 3 illustrates examples of equipment and examples of hole types;

FIG. 4 illustrates an example of a wellsite system and an example of a computing system;

FIG. 5 illustrates an example of equipment in a geologic environment;

FIG. 6 illustrates an example of a graphical user interface;

FIG. 7 illustrates an example of a graphical user interface;

FIG. 8 illustrates an example of a system;

FIG. 9 illustrates an example of a framework;

FIG. 10 illustrates an example of a method;

FIG. 11 illustrates an example of a graphical user interface;

FIG. 12 illustrates an example of a graphical user interface;

FIG. 13 illustrates examples of systems;

FIG. 14 illustrates an example of a table;

FIG. 15 illustrates an example of a graphical user interface;

FIG. 16 illustrates an example of a method and an example of a system;

FIG. 17 illustrates an example of a method;

FIG. 18 illustrates an example of a system;

FIG. 19 illustrates an example of a computing system; and

FIG. 20 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

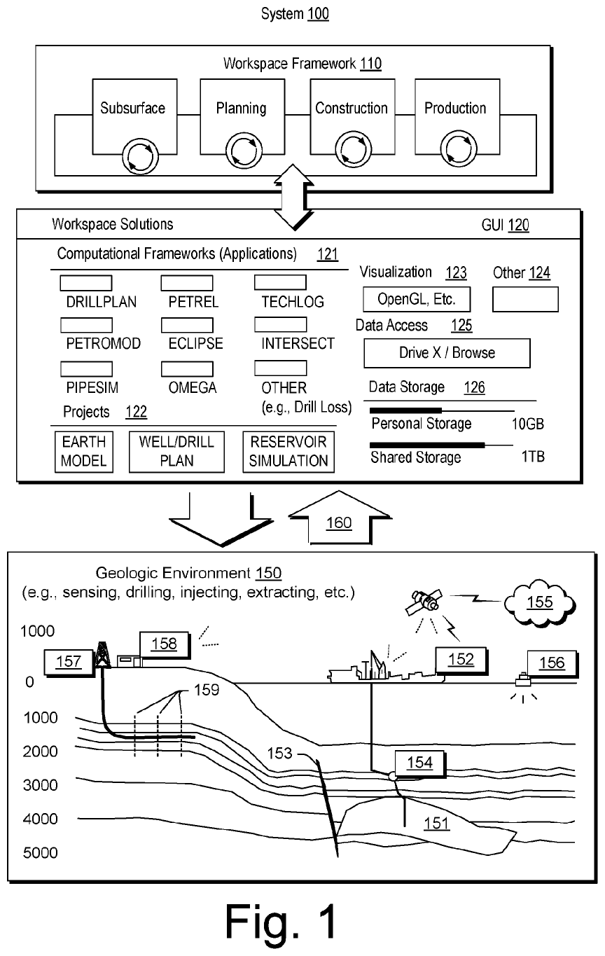

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, INTERSECT, PIPESIM and OMEGA frameworks (Schlumberger Limited, Houston, Texas). As to another type of framework, consider, for example, a drill loss framework, which may be operable in combination with one or more other frameworks to make determinations as to losses that may occur during one or more drilling operations, etc.

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (Schlumberger Limited, Houston, Texas) for utilization in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases. For example, a workflow may utilize one or more of the DELFI on demand reservoir simulation features.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (Schlumberger Limited, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The OMEGA framework includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density. Various features can be included for processing various types of data such as, for example, one or more of: land, marine, and transition zone data; time and depth data; 2D, 3D, and 4D surveys; isotropic and anisotropic (TTI and VTI) velocity fields; and multicomponent data.

The aforementioned DELFI environment, which is a secure, cognitive, cloud-based collaborative environment that integrates data and workflows with digital technologies, such as artificial intelligence and machine learning, provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process can implement one or more of various features that can be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter such that various types of code may be utilized within an environment such as, for example, the DELFI environment.

While several simulators are illustrated in the example of FIG. 1, one or more other simulators may be utilized, additionally or alternatively. For example, consider the VISAGE geomechanics simulator (Schlumberger Limited, Houston Texas), etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO₂ disposal, etc. The MANGROVE simulator (Schlumberger Limited, Houston, Texas) provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

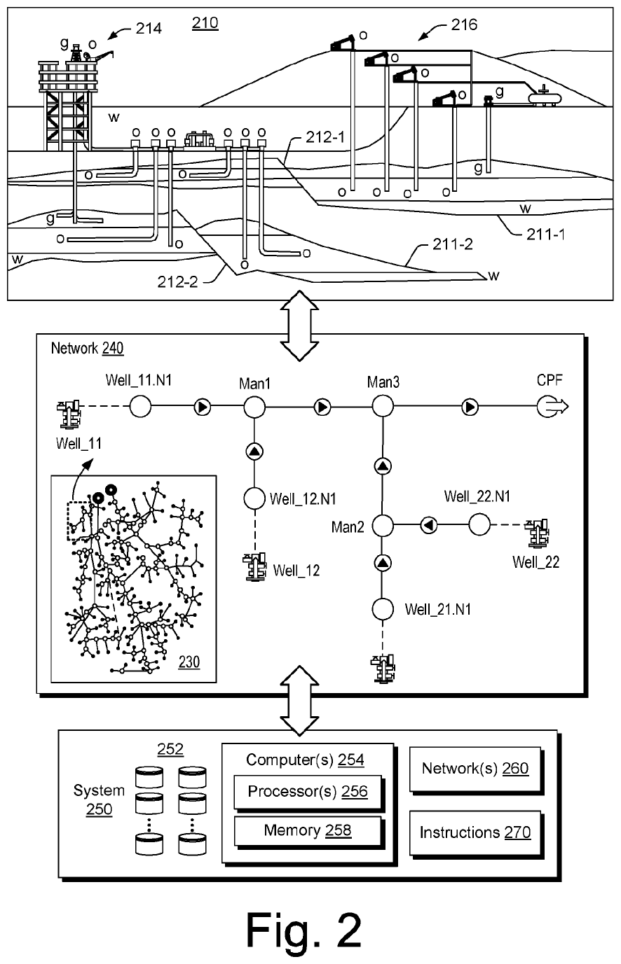

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows some examples of offshore equipment 214 for oil and gas operations related to the reservoir 211-2 and onshore equipment 216 for oil and gas operations related to the reservoir 211-1.

In the example of FIG. 2, the various equipment 214 and 216 can include drilling equipment, wireline equipment, production equipment, etc. For example, consider the equipment 214 as including a drilling rig that can drill into a formation to reach a reservoir target where a well can be completed for production of hydrocarbons. In such an example, one or more features of the system 100 of FIG. 1 may be utilized. For example, consider utilizing the DRILLPLAN framework to plan, execute, etc., one or more drilling operations.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of oil and gas fluids from well locations along flowlines interconnected at junctions with final delivery at a central processing facility.

In the example of FIG. 2, various portions of the network 240 may include conduit. For example, consider a perspective view of a geologic environment that includes two conduits which may be a conduit to Man1 and a conduit to Man3 in the network 240.

As shown in FIG. 2, the example system 250 includes one or more information storage devices 252, one or more computers 254, one or more networks 260 and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252. As an example, information that may be stored in one or more of the storage devices 252 may include information about equipment, location of equipment, orientation of equipment, fluid characteristics, etc.

As an example, the instructions 270 can include instructions (e.g., stored in the memory 258) executable by at least one of the one or more processors 256 to instruct the system 250 to perform various actions. As an example, the system 250 may be configured such that the instructions 270 provide for establishing a framework, for example, that can perform network modeling (see, e.g., the PIPESIM framework of the example of FIG. 1, etc.). As an example, one or more methods, techniques, etc. may be performed using one or more sets of instructions, which may be, for example, the instructions 270 of FIG. 2.

Equipment that may be at a site can include rig equipment. For example, consider rig equipment that includes a platform, a derrick, a crown block, a line, a traveling block assembly, drawworks and a landing (e.g., a monkeyboard). As an example, the line may be controlled at least in part via the drawworks such that the traveling block assembly travels in a vertical direction with respect to the platform. For example, by drawing the line in, the drawworks may cause the line to run through the crown block and lift the traveling block assembly skyward away from the platform; whereas, by allowing the line out, the drawworks may cause the line to run through the crown block and lower the traveling block assembly toward the platform. Where the traveling block assembly carries pipe (e.g., casing, etc.), tracking of movement of the traveling block may provide an indication as to how much pipe has been deployed.

A derrick can be a structure used to support a crown block and a traveling block operatively coupled to the crown block at least in part via line. A derrick may be pyramidal in shape and offer a suitable strength-to-weight ratio. A derrick may be movable as a unit or in a piece by piece manner (e.g., to be assembled and disassembled).

As an example, drawworks may include a spool, brakes, a power source and assorted auxiliary devices. Drawworks may controllably reel out and reel in line. Line may be reeled over a crown block and coupled to a traveling block to gain mechanical advantage in a “block and tackle” or “pulley” fashion. Reeling out and in of line can cause a traveling block (e.g., and whatever may be hanging underneath it), to be lowered into or raised out of a bore. Reeling out of line may be powered by gravity and reeling in by a motor, an engine, etc. (e.g., an electric motor, a diesel engine, etc.).

As an example, a crown block can include a set of pulleys (e.g., sheaves) that can be located at or near a top of a derrick or a mast, over which line is threaded. A traveling block can include a set of sheaves that can be moved up and down in a derrick or a mast via line threaded in the set of sheaves of the traveling block and in the set of sheaves of a crown block. A crown block, a traveling block and a line can form a pulley system of a derrick or a mast, which may enable handling of heavy loads (e.g., drillstring, pipe, casing, liners, etc.) to be lifted out of or lowered into a bore. As an example, line may be about a centimeter to about five centimeters in diameter as, for example, steel cable. Through use of a set of sheaves, such line may carry loads heavier than the line could support as a single strand.

As an example, a derrickman may be a rig crew member that works on a platform attached to a derrick or a mast. A derrick can include a landing on which a derrickman may stand. As an example, such a landing may be about 10 meters or more above a rig floor. In an operation referred to as trip out of the hole (TOH), a derrickman may wear a safety harness that enables leaning out from the work landing (e.g., monkeyboard) to reach pipe located at or near the center of a derrick or a mast and to throw a line around the pipe and pull it back into its storage location (e.g., fingerboards), for example, until it may be desirable to run the pipe back into the bore. As an example, a rig may include automated pipe-handling equipment such that the derrickman controls the machinery rather than physically handling the pipe.

As an example, a trip may refer to the act of pulling equipment from a bore and/or placing equipment in a bore. As an example, equipment may include a drillstring that can be pulled out of a hole and/or placed or replaced in a hole. As an example, a pipe trip may be performed where a drill bit has dulled or has otherwise ceased to drill efficiently and is to be replaced. As an example, a trip that pulls equipment out of a borehole may be referred to as pulling out of hole (POOH) and a trip that runs equipment into a borehole may be referred to as running in hole (RIH).

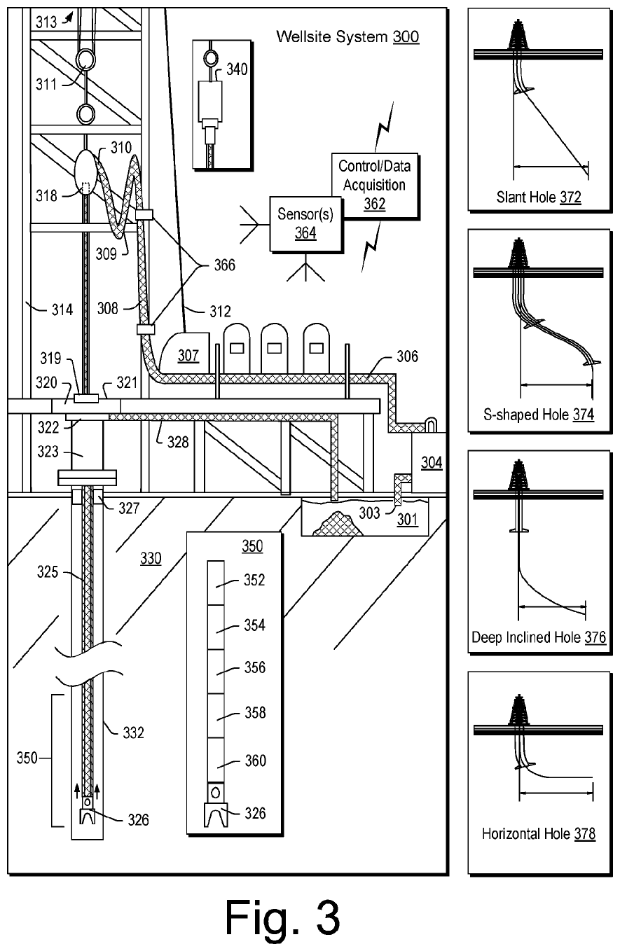

FIG. 3 shows an example of a wellsite system 300 (e.g., at a wellsite that may be onshore or offshore). As shown, the wellsite system 300 can include a mud tank 301 for holding mud and other material (e.g., where mud can be a drilling fluid), a suction line 303 that serves as an inlet to a mud pump 304 for pumping mud from the mud tank 301 such that mud flows to a vibrating hose 306, a drawworks 307 for winching drill line or drill lines 312, a standpipe 308 that receives mud from the vibrating hose 306, a kelly hose 309 that receives mud from the standpipe 308, a gooseneck or goosenecks 310, a traveling block 311, a crown block 313 for carrying the traveling block 311 via the drill line or drill lines 312, a derrick 314, a kelly 318 or a top drive 340, a kelly drive bushing 319, a rotary table 320, a drill floor 321, a bell nipple 322, one or more blowout preventors (BOPs) 323, a drillstring 325, a drill bit 326, a casing head 327 and a flow pipe 328 that carries mud and other material to, for example, the mud tank 301.

In the example system of FIG. 3, a borehole 332 is formed in subsurface formations 330 by rotary drilling; noting that various example embodiments may also use one or more directional drilling techniques, equipment, etc.

As shown in the example of FIG. 3, the drillstring 325 is suspended within the borehole 332 and has a drillstring assembly 350 that includes the drill bit 326 at its lower end. As an example, the drillstring assembly 350 may be a bottom hole assembly (BHA).

The wellsite system 300 can provide for operation of the drillstring 325 and other operations. As shown, the wellsite system 300 includes the traveling block 311 and the derrick 314 positioned over the borehole 332. As mentioned, the wellsite system 300 can include the rotary table 320 where the drillstring 325 pass through an opening in the rotary table 320.

As shown in the example of FIG. 3, the wellsite system 300 can include the kelly 318 and associated components, etc., or the top drive 340 and associated components. As to a kelly example, the kelly 318 may be a square or hexagonal metal/alloy bar with a hole drilled therein that serves as a mud flow path. The kelly 318 can be used to transmit rotary motion from the rotary table 320 via the kelly drive bushing 319 to the drillstring 325, while allowing the drillstring 325 to be lowered or raised during rotation. The kelly 318 can pass through the kelly drive bushing 319, which can be driven by the rotary table 320. As an example, the rotary table 320 can include a master bushing that operatively couples to the kelly drive bushing 319 such that rotation of the rotary table 320 can turn the kelly drive bushing 319 and hence the kelly 318. The kelly drive bushing 319 can include an inside profile matching an outside profile (e.g., square, hexagonal, etc.) of the kelly 318; however, with slightly larger dimensions so that the kelly 318 can freely move up and down inside the kelly drive bushing 319.

As to a top drive example, the top drive 340 can provide functions performed by a kelly and a rotary table. The top drive 340 can turn the drillstring 325. As an example, the top drive 340 can include one or more motors (e.g., electric and/or hydraulic) connected with appropriate gearing to a short section of pipe called a quill, that in turn may be screwed into a saver sub or the drillstring 325 itself. The top drive 340 can be suspended from the traveling block 311, so the rotary mechanism is free to travel up and down the derrick 314. As an example, a top drive 340 may allow for drilling to be performed with more joint stands than a kelly/rotary table approach.

In the example of FIG. 3, the mud tank 301 can hold mud, which can be one or more types of drilling fluids. As an example, a wellbore may be drilled to produce fluid, inject fluid or both (e.g., hydrocarbons, minerals, water, etc.).

In the example of FIG. 3, the drillstring 325 (e.g., including one or more downhole tools) may be composed of a series of pipes threadably connected together to form a long tube with the drill bit 326 at the lower end thereof. As the drillstring 325 is advanced into a wellbore for drilling, at some point in time prior to or coincident with drilling, the mud may be pumped by the pump 304 from the mud tank 301 (e.g., or other source) via a the lines 306, 308 and 309 to a port of the kelly 318 or, for example, to a port of the top drive 340. The mud can then flow via a passage (e.g., or passages) in the drillstring 325 and out of ports located on the drill bit 326 (see, e.g., a directional arrow). As the mud exits the drillstring 325 via ports in the drill bit 326, it can then circulate upwardly through an annular region between an outer surface(s) of the drillstring 325 and surrounding wall(s) (e.g., open borehole, casing, etc.), as indicated by directional arrows. In such a manner, the mud lubricates the drill bit 326 and carries heat energy (e.g., frictional or other energy) and formation cuttings to the surface where the mud (e.g., and cuttings) may be returned to the mud tank 301, for example, for recirculation (e.g., with processing to remove cuttings, etc.).

The mud pumped by the pump 304 into the drillstring 325 may, after exiting the drillstring 325, form a mudcake that lines the wellbore which, among other functions, may reduce friction between the drillstring 325 and surrounding wall(s) (e.g., borehole, casing, etc.). A reduction in friction may facilitate advancing or retracting the drillstring 325. During a drilling operation, the entire drillstring 325 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 326 of the drillstring 325 at a bottom of a wellbore, pumping of the mud commences to lubricate the drill bit 326 for purposes of drilling to enlarge the wellbore. As mentioned, the mud can be pumped by the pump 304 into a passage of the drillstring 325 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may modulated. In such an example, information from downhole equipment (e.g., one or more modules of the drillstring 325) may be transmitted uphole to an uphole device, which may relay such information to other equipment for processing, control, etc.

As an example, telemetry equipment may operate via transmission of energy via the drillstring 325 itself. For example, consider a signal generator that imparts coded energy signals to the drillstring 325 and repeaters that may receive such energy and repeat it to further transmit the coded energy signals (e.g., information, etc.).

As an example, the drillstring 325 may be fitted with telemetry equipment 352 that includes a rotatable drive shaft, a turbine impeller mechanically coupled to the drive shaft such that the mud can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 3, an uphole control and/or data acquisition system 362 may include circuitry to sense pressure pulses generated by telemetry equipment 352 and, for example, communicate sensed pressure pulses or information derived therefrom for process, control, etc.

The assembly 350 of the illustrated example includes a logging-while-drilling (LWD) module 354, a measurement-while-drilling (MWD) module 356, an optional module 358, a rotary-steerable system (RSS) and/or motor 360, and the drill bit 326. Such components or modules may be referred to as tools where a drillstring can include a plurality of tools.

As to a RSS, it involves technology utilized for directional drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling can commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

One approach to directional drilling involves a mud motor; however, a mud motor can present some challenges depending on factors such as rate of penetration (ROP), transferring weight to a bit (e.g., weight on bit, WOB) due to friction, etc. A mud motor can be a positive displacement motor (PDM) that operates to drive a bit (e.g., during directional drilling, etc.). A PDM operates as drilling fluid is pumped through it where the PDM converts hydraulic power of the drilling fluid into mechanical power to cause the bit to rotate.

As an example, a PDM may operate in a combined rotating mode where surface equipment is utilized to rotate a bit of a drillstring (e.g., a rotary table, a top drive, etc.) by rotating the entire drillstring and where drilling fluid is utilized to rotate the bit of the drillstring. In such an example, a surface RPM (SRPM) may be determined by use of the surface equipment and a downhole RPM of the mud motor may be determined using various factors related to flow of drilling fluid, mud motor type, etc. As an example, in the combined rotating mode, bit RPM can be determined or estimated as a sum of the SRPM and the mud motor RPM, assuming the SRPM and the mud motor RPM are in the same direction.

As an example, a PDM mud motor can operate in a so-called sliding mode, when the drillstring is not rotated from the surface. In such an example, a bit RPM can be determined or estimated based on the RPM of the mud motor.

A RSS can drill directionally where there is continuous rotation from surface equipment, which can alleviate the sliding of a steerable motor (e.g., a PDM). A RSS may be deployed when drilling directionally (e.g., deviated, horizontal, or extended-reach wells). A RSS can aim to minimize interaction with a borehole wall, which can help to preserve borehole quality. A RSS can aim to exert a relatively consistent side force akin to stabilizers that rotate with the drillstring or orient the bit in the desired direction while continuously rotating at the same number of rotations per minute as the drillstring.

The LWD module 354 may be housed in a suitable type of drill collar and can contain one or a plurality of selected types of logging tools. It will also be understood that more than one LWD and/or MWD module can be employed, for example, as represented at by the module 356 of the drillstring assembly 350. Where the position of an LWD module is mentioned, as an example, it may refer to a module at the position of the LWD module 354, the module 356, etc. An LWD module can include capabilities for measuring, processing, and storing information, as well as for communicating with the surface equipment. In the illustrated example, the LWD module 354 may include a seismic measuring device.

The MWD module 356 may be housed in a suitable type of drill collar and can contain one or more devices for measuring characteristics of the drillstring 325 and the drill bit 326. As an example, the MWD tool 354 may include equipment for generating electrical power, for example, to power various components of the drillstring 325. As an example, the MWD tool 354 may include the telemetry equipment 352, for example, where the turbine impeller can generate power by flow of the mud; it being understood that other power and/or battery systems may be employed for purposes of powering various components. As an example, the MWD module 356 may include one or more of the following types of measuring devices: a weight-on-bit measuring device, a torque measuring device, a vibration measuring device, a shock measuring device, a stick slip measuring device, a direction measuring device, and an inclination measuring device.

FIG. 3 also shows some examples of types of holes that may be drilled. For example, consider a slant hole 372, an S-shaped hole 374, a deep inclined hole 376 and a horizontal hole 378.

As an example, a drilling operation can include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees.

As an example, a directional well can include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of a downhole motor and/or a turbine. As to a motor, for example, a drillstring can include a positive displacement motor (PDM).

As an example, a system may be a steerable system and include equipment to perform method such as geosteering. As mentioned, a steerable system can be or include an RSS. As an example, a steerable system can include a PDM or of a turbine on a lower part of a drillstring which, just above a drill bit, a bent sub can be mounted. As an example, above a PDM, MWD equipment that provides real time or near real time data of interest (e.g., inclination, direction, pressure, temperature, real weight on the drill bit, torque stress, etc.) and/or LWD equipment may be installed. As to the latter, LWD equipment can make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, can allow for implementing a geosteering method. Such a method can include navigating a subsurface environment, for example, to follow a desired route to reach a desired target or targets.

As an example, a drillstring can include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

As an example, geosteering can include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 3, the wellsite system 300 can include one or more sensors 364 that are operatively coupled to the control and/or data acquisition system 362. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 300. As an example, a sensor or sensor may be at an offset wellsite where the wellsite system 300 and the offset wellsite are in a common field (e.g., oil and/or gas field).

As an example, one or more of the sensors 364 can be provided for tracking pipe, tracking movement of at least a portion of a drillstring, etc.

As an example, the system 300 can include one or more sensors 366 that can sense and/or transmit signals to a fluid conduit such as a drilling fluid conduit (e.g., a drilling mud conduit). For example, in the system 300, the one or more sensors 366 can be operatively coupled to portions of the standpipe 308 through which mud flows. As an example, a downhole tool can generate pulses that can travel through the mud and be sensed by one or more of the one or more sensors 366. In such an example, the downhole tool can include associated circuitry such as, for example, encoding circuitry that can encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 300 can include a transmitter that can generate signals that can be transmitted downhole via mud (e.g., drilling fluid) as a transmission medium.

During drilling operations, one or more portions of a drillstring may become stuck. The term stuck can refer to one or more of varying degrees of inability to move or remove a drillstring from a bore. As an example, in a stuck condition, it might be possible to rotate pipe or lower it back into a bore or, for example, in a stuck condition, there may be an inability to move the drillstring axially in the bore, though some amount of rotation may be possible. As an example, in a stuck condition, there may be an inability to move at least a portion of the drillstring axially and rotationally.

As to the term “stuck pipe”, this can refer to a portion of a drillstring that cannot be rotated or moved axially. As an example, a condition referred to as “differential sticking” can be a condition whereby the drillstring cannot be moved (e.g., rotated or reciprocated) along the axis of the bore. Differential sticking may occur when high-contact forces caused by low reservoir pressures, high wellbore pressures, or both, are exerted over a sufficiently large area of the drillstring. Differential sticking can have time and financial cost.

As an example, a sticking force can be a product of the differential pressure between the wellbore and the reservoir and the area that the differential pressure is acting upon. This means that a relatively low differential pressure (delta p) applied over a large working area can be just as effective in sticking pipe as can a high differential pressure applied over a small area.

As an example, a condition referred to as “mechanical sticking” can be a condition where limiting or prevention of motion of the drillstring by a mechanism other than differential pressure sticking occurs. Mechanical sticking can be caused, for example, by one or more of junk in the hole, wellbore geometry anomalies, cement, keyseats or a buildup of cuttings in the annulus.

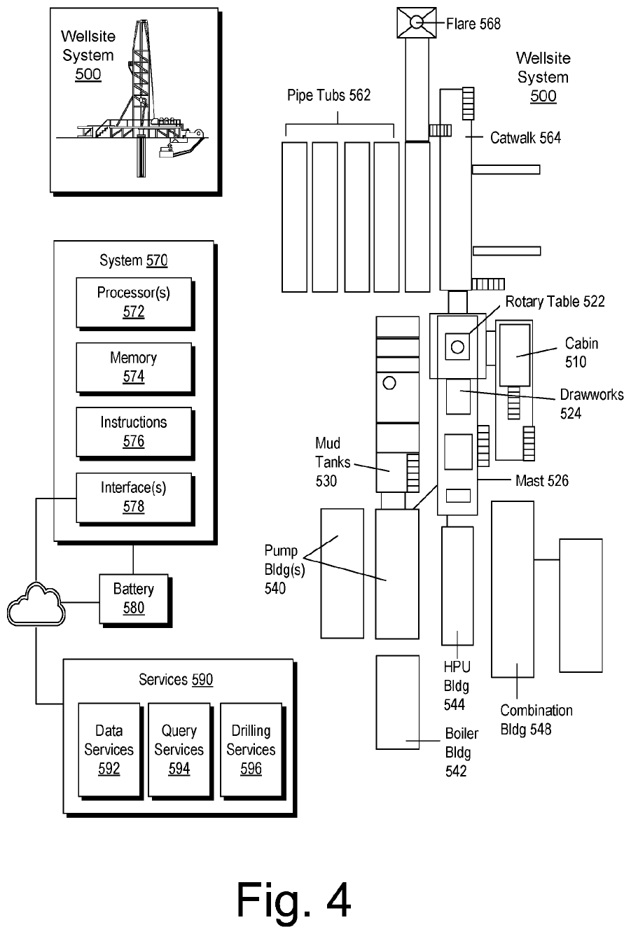

FIG. 4 shows an example of a wellsite system 400, specifically, FIG. 4 shows the wellsite system 400 in an approximate side view and an approximate plan view along with a block diagram of a system 470.

In the example of FIG. 4, the wellsite system 400 can include a cabin 410, a rotary table 422, drawworks 424, a mast 426 (e.g., optionally carrying a top drive, etc.), mud tanks 430 (e.g., with one or more pumps, one or more shakers, etc.), one or more pump buildings 440, a boiler building 442, an HPU building 444 (e.g., with a rig fuel tank, etc.), a combination building 448 (e.g., with one or more generators, etc.), pipe tubs 462, a catwalk 464, a flare 468, etc. Such equipment can include one or more associated functions and/or one or more associated operational risks, which may be risks as to time, resources, and/or humans.

As shown in the example of FIG. 4, the wellsite system 400 can include a system 470 that includes one or more processors 472, memory 474 operatively coupled to at least one of the one or more processors 472, instructions 476 that can be, for example, stored in the memory 474, and one or more interfaces 478. As an example, the system 470 can include one or more processor-readable media that include processor-executable instructions executable by at least one of the one or more processors 472 to cause the system 470 to control one or more aspects of the wellsite system 400. In such an example, the memory 474 can be or include the one or more processor-readable media where the processor-executable instructions can be or include instructions. As an example, a processor-readable medium can be a computer-readable storage medium that is not a signal and that is not a carrier wave.

FIG. 4 also shows a battery 480 that may be operatively coupled to the system 470, for example, to power the system 470. As an example, the battery 480 may be a back-up battery that operates when another power supply is unavailable for powering the system 470. As an example, the battery 480 may be operatively coupled to a network, which may be a cloud network. As an example, the battery 480 can include smart battery circuitry and may be operatively coupled to one or more pieces of equipment via a SMBus or other type of bus.

As an example, the system 470 may be utilized to generate one or more rate of penetration drilling parameter values, which may, for example, be utilized to control one or more drilling operations.

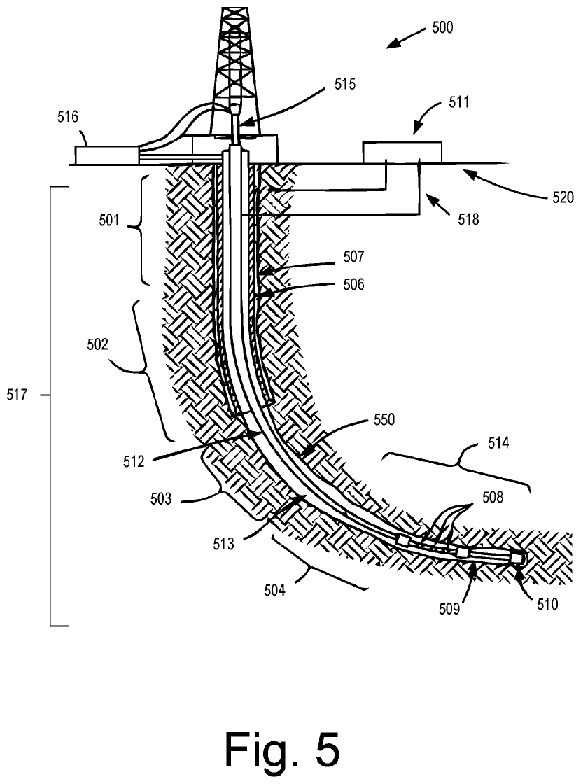

FIG. 5 shows a schematic diagram depicting an example of a drilling operation of a directional well in multiple sections. The drilling operation depicted in FIG. 5 includes a wellsite drilling system 500 and a field management tool 520 for managing various operations associated with drilling a bore hole 550 of a directional well 517. The wellsite drilling system 500 includes various components (e.g., drillstring 512, annulus 513, bottom hole assembly (BHA) 514, kelly 515, mud pit 516, etc.). As shown in the example of FIG. 5, a target reservoir may be located away from (as opposed to directly under) the surface location of the well 517. In such an example, special tools or techniques may be used to ensure that the path along the bore hole 550 reaches the particular location of the target reservoir.

As an example, the BHA 514 may include sensors 508, a rotary steerable system (RSS) 509, and a bit 510 to direct the drilling toward the target guided by a pre-determined survey program for measuring location details in the well. Furthermore, the subterranean formation through which the directional well 517 is drilled may include multiple layers (not shown) with varying compositions, geophysical characteristics, and geological conditions. Both the drilling planning during the well design stage and the actual drilling according to the drilling plan in the drilling stage may be performed in multiple sections (see, e.g., sections 501, 502, 503 and 504), which may correspond to one or more of the multiple layers in the subterranean formation. For example, certain sections (e.g., sections 501 and 502) may use cement 507 reinforced casing 506 due to the particular formation compositions, geophysical characteristics, and geological conditions.

In the example of FIG. 5, a surface unit 511 may be operatively linked to the wellsite drilling system 500 and the field management tool 520 via communication links 518. The surface unit 511 may be configured with functionalities to control and monitor the drilling activities by sections in real time via the communication links 518. The field management tool 520 may be configured with functionalities to store oilfield data (e.g., historical data, actual data, surface data, subsurface data, equipment data, geological data, geophysical data, target data, anti-target data, etc.) and determine relevant factors for configuring a drilling model and generating a drilling plan. The oilfield data, the drilling model, and the drilling plan may be transmitted via the communication link 518 according to a drilling operation workflow. The communication links 518 may include a communication subassembly.

During various operations at a wellsite, data can be acquired for analysis and/or monitoring of one or more operations. Such data may include, for example, subterranean formation, equipment, historical and/or other data. Static data can relate to, for example, formation structure and geological stratigraphy that define the geological structures of the subterranean formation. Static data may also include data about a bore, such as inside diameters, outside diameters, and depths. Dynamic data can relate to, for example, fluids flowing through the geologic structures of the subterranean formation over time. The dynamic data may include, for example, pressures, fluid compositions (e.g. gas oil ratio, water cut, and/or other fluid compositional information), and states of various equipment, and other information.

The static and dynamic data collected via a bore, a formation, equipment, etc. may be used to create and/or update a three dimensional model of one or more subsurface formations. As an example, static and dynamic data from one or more other bores, fields, etc. may be used to create and/or update a three dimensional model. As an example, hardware sensors, core sampling, and well logging techniques may be used to collect data. As an example, static measurements may be gathered using downhole measurements, such as core sampling and well logging techniques. Well logging involves deployment of a downhole tool into the wellbore to collect various downhole measurements, such as density, resistivity, etc., at various depths. Such well logging may be performed using, for example, a drilling tool and/or a wireline tool, or sensors located on downhole production equipment. Once a well is formed and completed, depending on the purpose of the well (e.g., injection and/or production), fluid may flow to the surface (e.g., and/or from the surface) using tubing and other completion equipment. As fluid passes, various dynamic measurements, such as fluid flow rates, pressure, and composition may be monitored. These parameters may be used to determine various characteristics of a subterranean formation, downhole equipment, downhole operations, etc.

As an example, a system can include a framework that can acquire data such as, for example, real time data associated with one or more operations such as, for example, a drilling operation or drilling operations. As an example, consider the PERFORM toolkit framework (Schlumberger Limited, Houston, Texas).

As an example, a service can be or include one or more of OPTIDRILL, OPTILOG and/or other services marketed by Schlumberger Limited, Houston, Texas.

The OPTIDRILL technology can help to manage downhole conditions and BHA dynamics as a real time drilling intelligence service. The service can incorporate a rigsite display (e.g., a wellsite display) of integrated downhole and surface data that provides actionable information to mitigate risk and increase efficiency. As an example, such data may be stored, for example, to a database system (e.g., consider a database system associated with the STUDIO framework).

The OPTILOG technology can help to evaluate drilling system performance with single- or multiple-location measurements of drilling dynamics and internal temperature from a recorder. As an example, post-run data can be analyzed to provide input for future well planning.

As an example, information from a drill bit database may be accessed and utilized. For example, consider information from Smith Bits (Schlumberger Limited, Houston, Texas), which may include information from various operations (e.g., drilling operations) as associated with various drill bits, drilling conditions, formation types, etc.

As an example, one or more QTRAC services (Schlumberger Limited, Houston Texas) may be provided for one or more wellsite operations. In such an example, data may be acquired and stored where such data can include time series data that may be received and analyzed, etc.

As an example, one or more M-I SWACO services (M-I L.L.C., Houston, Texas) may be provided for one or more wellsite operations. For example, consider services for value-added completion and reservoir drill-in fluids, additives, cleanup tools, and engineering. In such an example, data may be acquired and stored where such data can include time series data that may be received and analyzed, etc.

As an example, one or more ONE-TRAX services (e.g., via the ONE-TRAX software platform, M-I L.L.C., Houston, Texas) may be provided for one or more wellsite operations. In such an example, data may be acquired and stored where such data can include time series data that may be received and analyzed, etc.

As an example, various operations can be defined with respect to WITS or WITSML, which are acronyms for well-site information transfer specification or standard (WITS) and markup language (WITSML). WITS/WITSML specify how a drilling rig or offshore platform drilling rig can communicate data. For example, as to slips, which are an assembly that can be used to grip a drillstring in a relatively non-damaging manner and suspend the drillstring in a rotary table, WITS/WITSML define operations such as “bottom to slips” time as a time interval between coming off bottom and setting slips, for a current connection; “in slips” as a time interval between setting the slips and then releasing them, for a current connection; and “slips to bottom” as a time interval between releasing the slips and returning to bottom (e.g., setting weight on the bit), for a current connection.

Well construction can occur according to various procedures, which can be in various forms. As an example, a procedure can be specified digitally and may be, for example, a digital plan such as a digital well plan. A digital well plan can be an engineering plan for constructing a wellbore. As an example, procedures can include information such as well geometries, casing programs, mud considerations, well control concerns, initial bit selections, offset well information, pore pressure estimations, economics and special procedures that may be utilized during the course of well construction, production, etc. While a drilling procedure can be carefully developed and specified, various conditions can occur that call for adjustment to a drilling procedure.

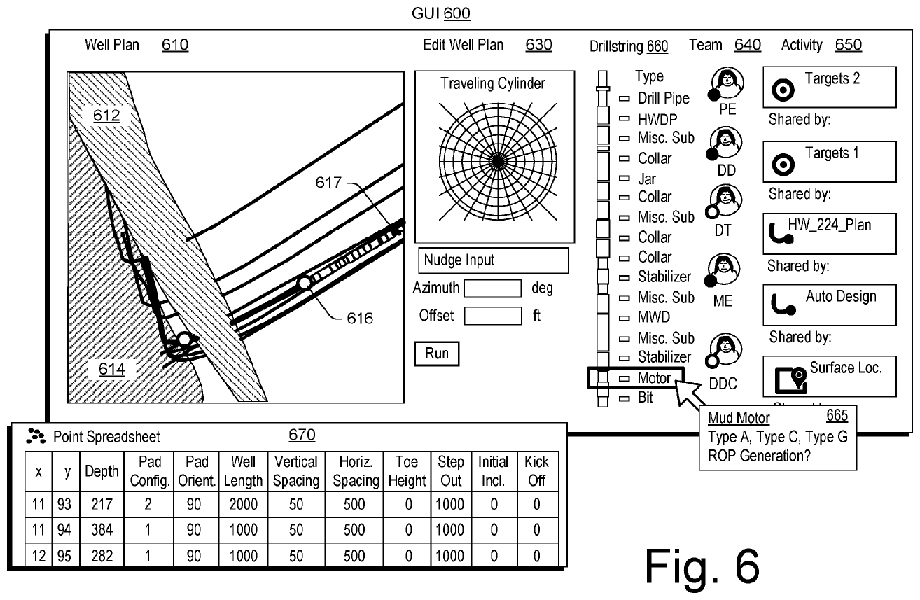

FIG. 6 shows an example of a graphical user interface (GUI) 600 that includes information associated with a well plan. Specifically, the GUI 600 includes a panel 610 where surfaces representations 612 and 614 are rendered along with well trajectories where a location 616 can represent a position of a drillstring 617 along a well trajectory. The GUI 600 may include one or more editing features such as an edit well plan set of features 630. The GUI 600 may include information as to individuals of a team 640 that are involved, have been involved and/or are to be involved with one or more operations. The GUI 600 may include information as to one or more activities 650.

As shown in the example of FIG. 6, the GUI 600 can include a graphical control of a drillstring 660 where, for example, various portions of the drillstring 660 may be selected to expose one or more associated parameters (e.g., type of equipment, equipment specifications, operational history, etc.). In the example of FIG. 6, the drillstring graphical control 660 includes components such as drill pipe, heavy weight drill pipe (HWDP), subs, collars, jars, stabilizers, motor(s) and a bit. A drillstring can be a combination of drill pipe, a bottom hole assembly (BHA) and one or more other tools, which can include one or more tools that can help a drill bit turn and drill into material (e.g., a formation).

As an example, a workflow can include utilizing the graphical control of the drillstring 660 to select and/or expose information associated with a component or components such as, for example, a bit and/or a mud motor. In the example of FIG. 6, a graphical control 665 is shown that can be rendered responsive to interaction with the graphical control of the drillstring 660, for example, to select a type of component and/or to specify one or more features of the drillstring 660 (e.g., for training a neural network model, etc.). As to the graphical control 665, it may provide output to a drill loss framework, as the type of motor and/or use thereof may impact losing during one or more field operations. As explained, a drill bit may be rotated via one or more mechanisms (e.g., rotary drive, top drive, mud motor, etc.). Such modes of operation can be associated with particular types of energy utilization. As an example, the GUI 600 can include one or more fields and/or pop-ups that can be generated based at least in part on output of a drill loss framework. For example, consider the graphical control 665 being highlighted as to a particular type of mud motor that will make a field operation (e.g., drilling) more efficient and/or otherwise reduce drilling losses (e.g., compared to another mode, etc.).

FIG. 6 also shows an example of a table 670 as a point spreadsheet that specifies information for a plurality of wells. As shown in the example table 670, coordinates such as “x” and “y” and “depth” can be specified for various features of the wells, which can include pad parameters, spacings, toe heights, step outs, initial inclinations, kick offs, etc.

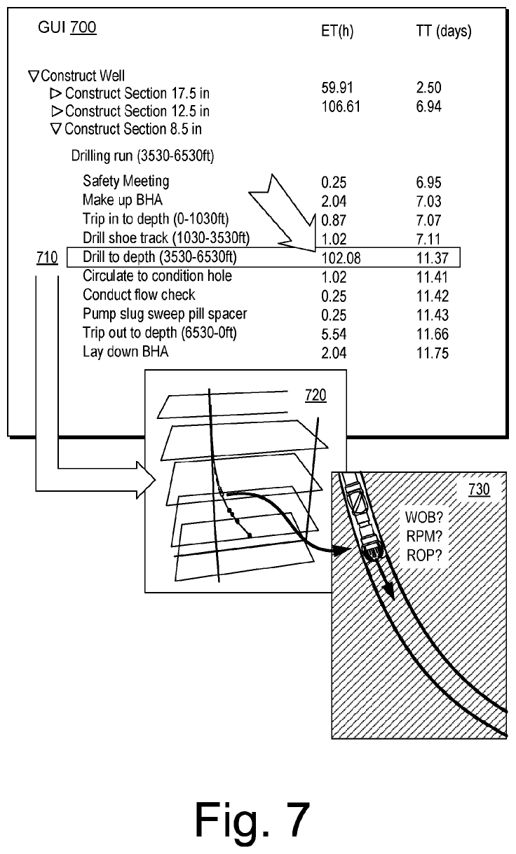

FIG. 7 shows an example of a graphical user interface 700 that includes various types of information for construction of a well where times are rendered for corresponding actions. In the example of FIG. 7, the times are shown as an estimated time (ET) in hours and a total or cumulative time (TT), which is in days. Another time may be a clean time, which can be for performing an action or actions without occurrence of non-productive time (NPT) while the estimated time (ET) can include NPT, which may be determined using one or more databases, probabilistic analysis, etc. In the example of FIG. 7, the total time (TT or cumulative time) may be a sum of the estimated time column. As an example, during execution and/or replanning the GUI 700 may be rendered and revised accordingly to reflect changes. As shown in the example of FIG. 7, the GUI 700 can include selectable elements and/or highlightable elements. As an example, an element may be highlighted responsive to a signal that indicates that an activity is currently being performed, is staged, is to be revised, etc. For example, a color coding scheme may be utilized to convey information to a user via the GUI 700.

As to the highlighted element 710 (“Drill to depth (3530-6530 ft)”) the estimated time is 102.08 hours, which is greater than four days. For the drilling run for the 8.5 inch section of the borehole, the highlighted element 710 is the longest in terms of estimated time. FIG. 7 also shows a GUI 720 for a borehole trajectory and a GUI 730 of a drillstring with a drill bit where drilling may proceed according to a weight on bit (WOB) and a rotational speed (RPM) to achieve a rate of penetration (ROP). In the example of FIG. 7, the GUI 730 and parameters thereof may be associated with energy utilization and losses and/or other impact.

As an example, the GUI 730 may be operatively coupled to a drill loss framework such that, for example, variations in RPM and/or WOB can be visualized with respect to prospective drilling-related loss events, which may provide for optimizations, control, etc. As an example, an ROP may be associated with drilling-related losses where an optimal ROP may be an ROP that considers potential to incur drilling-related losses. For example, consider an ROP per unit energy expended and/or type of drilling-related loss associated with that energy expenditure. In such an example, changes may occur in a manner dependent on mode of drilling (e.g., rotational, sliding, etc.). As an example, an optimization scheme may aim to optimize the drilling run within the limits drilling-related losses.

As an example, the GUI 700 can be operatively coupled to one or more systems that can assist and/or control one or more drilling operations. For example, consider a system that generates rate of penetration values, which may be, for example, rate of penetration set points. Such a system may be an automation assisted system and/or a control system. For example, a system may render a GUI that displays one or more generated rate of penetration values and/or a system may issue one or more commands to one or more pieces of equipment to cause operation thereof at a generated rate of penetration (e.g., per a WOB, a RPM, etc.). As an example, a time estimate may be given for the drill to depth operation using manual, automated and/or semi-automated drilling. For example, where a driller enters a sequence of modes, the time estimate may be based on that sequence; whereas, for an automated approach, a sequence can be generated (e.g., an estimated automated sequence, a recommended estimated sequence, etc.) with a corresponding time estimate. In such an approach, a driller may compare the sequences and select one or the other or, for example, generate a hybrid sequence (e.g., part manual and part automated, etc.).

As an example, a system can include a framework for drilling-related losses (e.g., a drill loss framework). For example, consider a framework for drilling-related loss predictions where the framework may be part of a framework environment such as in the system 100 of FIG. 1.

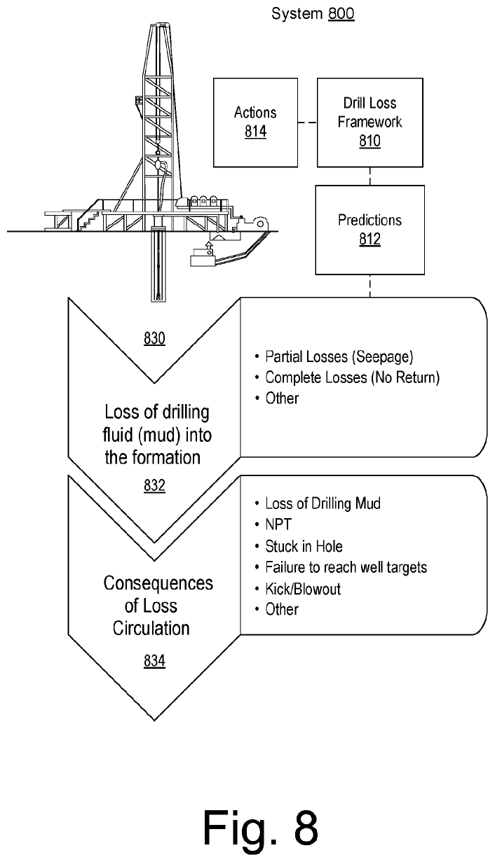

FIG. 8 shows an example of a system 800 that can detect various types of drilling losses. As shown, the system 800 includes a drill loss framework 810 that can operate using real-time data from field equipment and that can output information such as, for example, predictions 812 and/or actions 814. As an example, output information may include one or more of one or more alarms, one or more control signals, etc. In such an example, one or more actions can be taken in the field utilizing various field equipment to reduce drilling losses (e.g., to reduce risk of occurrence, to reduce consequence(s) of occurrence, etc.).

The example of FIG. 8 shows an example of a cascade 830 where loss of drilling fluid (mud) into a formation 832 can result in consequences of loss of circulation 834. In such an example, loss of drilling fluid 832 can include partial losses of drilling fluid can be via seepage where complete losses of drilling fluid may occur where there is little to no return of lost drilling fluid. In such an example, consequences of loss of circulation 834 can include loss of drilling fluid that can result in one or more of non-productive time (NPT), sticking (e.g., stuck in hole), failure to reach targets per schedule (e.g., per a well plan, etc.), kick, blowout, etc.

Loss of circulation or circulation loss involves loss of at least some drilling fluid to a formation, which may be caused when the hydrostatic head pressure of the column of drilling fluid exceeds the formation pressure. Such loss of fluid may be approximately classified, for example, as one of seepage loss, partial loss, catastrophic loss, etc., where each of which may be addressed appropriately via one or more actions, for example, depending on risk to equipment, personnel, borehole quality/integrity, etc.

As to hydrostatic pressure, it can be the normal, predicted pressure for a given depth, or the pressure exerted per unit area by a column of freshwater from sea level to a given depth. In various instances, abnormally low pressure might occur in areas where fluids have been drained, such as a depleted hydrocarbon reservoir. In various instances, abnormally high pressure might occur in areas where burial of water-filled sediments by impermeable sediment such as clay was so rapid that fluids could not escape and the pore pressure increased with deeper burial.

As an example, a channel can be for real-time streaming data from equipment at a wellsite. For example, consider a standpipe pressure (SPPA) channel. As shown in FIG. 3, the standpipe 308 can be a rigid metal conduit that provides a high-pressure pathway for drilling fluid (mud) to travel approximately one-third of the way up a derrick, where it connects to a flexible high-pressure hose (see, e.g., the kelly hose 309). As an example, a rig may be fit with more than one standpipe such that downtime (e.g., non-productive time (NPT)) may be kept to a minimum if one standpipe demands servicing (e.g., repair, etc.). As an example, a mud flow rate in (FLWI) can be another channel. The rate of drilling fluid (mud) flowing into a well can be measured via one or more sensors. Drilling fluid (mud) flowing into a well may be sampled and referred to as a mud-in sample, which may be taken from a suction pit (e.g., the last pit in a flow series) just before the mud goes into a pump and down a wellbore. Drilling fluid characteristics (e.g., mud characteristics) can be addressed using one or more mud-in samples, which may help to assure that it is properly weighted and is in good condition to encounter downhole pressures, temperatures and contamination. As an example, a system may provide for taking mud-out samples where, for example, one or more comparisons may be made between properties of a mud-in sample and a mud-out sample (e.g., taken at surface prior to solids removal). As an example, an action as to one or more drilling fluid related issues may involve one or more adjustments to drilling, drilling fluid characteristics (e.g., properties), drilling fluid movement, drilling fluid solids removal, etc.

As to drilling, one or more drilling actions may be taken, for example, consider reducing rate of penetration (ROP), changing from a sliding mode to a rotating mode, changing from a rotating mode to a sliding mode, etc. As explained, a positive displacement motor (PDM) may be utilized that is driven by flow of drilling fluid (e.g., a PDM mud motor) such that loss of fluid may impact operation of such a PDM.

The system 800 can provide for early downhole problem detection. Such problems can include foreseeing drilling problems such as one or more of fluid losses, kicks, stuck pipe, etc. The system 800 can utilize one or more machine learning models (e.g., artificial intelligence, etc.) where a trained machine learning model can be a predictive model that can receive information and make predictions based at least in part on such information.

As explained, field equipment can include various types of sensors that can acquire data related to drilling. For example, consider rate of penetration (ROP), mud pit levels, surface torque, downhole torque, stand pipe pressure (SPP), etc. As an example, a machine learning approach can utilize various types of data for purposes of training and/or testing. For example, consider using data from a particular well and/or using data from offset wells that are offset from a well, which may be referred to as a target well that is planned to be drilled, currently being drilled, etc. As an example, a database or databases of offset well data may be utilized to train a machine learning model or models to output predictions where training can include testing. As an example, a machine learning model may be trained in an online manner such that a trained machine learning model increases its ability to make predictions during online use.

As explained, the system 800 can include one or more machine learning models, for example, as part of the drill loss framework 810, to make prediction in real-time during drilling operations at one or more wells.

As to types of losses to predict, the system 800 may focus on most frequent and severe drilling problems-downhole losses. In various trials, the system 800 utilized a trained machine learning model to predict such losses. Such an approach may be tailored to a particular geography, particular equipment, particular types of wells, etc. For example, consider accessing offset well data according to particular criteria that may match or closely match criteria of a target well where the system 800 is to be implemented in real-time during drilling operations.

As to output, the system 800 can operate to output information that abides by generally accepted drilling practices. For example, consider so-called “loss-safe” drilling practices, as a measure against drilling fluid (mud) losses, which can result in, for example, one or more of increased NPT, reduced ROP, reduced flowrates, reduced surge/swab, etc. However, in various instances, drilling with “loss-safe” drilling parameters can take a toll on drilling performance such as substantial reductions in distance drilled per day. While “loss-safe” drilling practices can help to reduce occurrence of various types of losses, such practices can be overly cautious as risk mitigation efforts that tradeoff reduced risk as to unknown possible costs for increased known costs. The system 800 can provide for risk mitigation while allowing for more streamlined drilling practices, particularly where risks may be deemed to be small or otherwise minimal per machine learning model predictions. The system 800 can output information that can, for example, proactively alert a drilling operator in real-time as to when to use “performance parameters” for maximum ROP and when to switch to use of “loss-safe” parameters. In such an approach, “loss-safe” practices can be implemented in an on-demand manner where, for example, a level of risk may be set and/or adjusted (e.g., automatically, manually, etc.). For example, consider a drilling operator that is familiar with a particular field and equipment (e.g., a rig, BHA, etc.) such that the drilling operator is skilled and knowledgeable for performing drilling operations for a target well. In such an example, the drilling operator may set a risk level that allows for increased performance drilling; whereas, if a drilling operator is less familiar, a risk level may be set that tends toward use of “loss-safe” parameters.

In various trials, a system such as the system 800 was implemented in a manner whereby downhole losses were reduced by 77 percent, leading to substantial savings and reduction of risk (e.g., as to equipment, borehole integrity, humans, etc.). As an example, a system such as the system 800 can be utilized in real-time during drilling and/or during planning and/or re-planning. For example, consider a planning implementation where a plan can be simulated by a drilling simulator where output of the drilling simulator (e.g., simulation results) can be input to the system 800 to output predictions as to one or more types of drill losses. In such an example, a plan can be revised, tailored, etc., as appropriate, and then utilized in the field to guide field operations.

As an example, the system 800 can output predictions that can help to reduce lost-circulation types of losses to aid in well planning, generating real-time alarms, etc. In such an approach, lost-circulation revenue leaks can be reduced by pre-identifying losses using a trained machine learning model. One or more instances of the system 800 can allow teams to identify one or more types of problems prior to occurrence such that actions can be taken to stop and/or reduce impact of an event (e.g., by taking appropriate preventive and mitigation measures).

As an example, the system 800 can be implemented in a manner where false positive predictions and/or false negative predictions can be tailored. As explained, these may be tailored through use of a risk level setting. As an example, feedback from one or more sites can be utilized for re-training one or more machine learning models and/or by imposing one or more types of filters on output. The system 800 can be more robust and adaptable than reactive systems that may be quite susceptible to human error.

The system 800 can be customizable and proactive, provide for continuous learning and may be free of influence by human error in making predictions as to drill loss events.

As explained, a machine learning (ML) model can be trained using data from a particular field, which may makes the ML model customized to that field. As explained, a ML model may be updated automatically such that continuous learning occurs, for example, using current operations. As training data and machine training (e.g., learning) techniques determine weights, etc., that dictate operation of a ML model, training can be free of human error. In various instances, a ML model can be able to make predictions that a human may not be readily capable of making. For example, a ML model can provide for discovery of patterns and learning of such patterns as being associated with drill loss risks.

As to generating a trained ML model, a cloud-based approach may be implemented where compute power and memory are available via provisioning. In various instances, training data (e.g., and testing data) may be terabytes of data or more. Such data can include sensor-based data that may be acquired on an appropriate basis (e.g., from less than 1 Hz to 1 Hz or more).

A ML model framework can be cloud-based where various types of sensor-based data (e.g., acquired and recorded via drilling operations) flow to cloud-based resources via one or more networks. As to implementation of a trained ML model, it may demand lesser resources than training. For example, a trained ML model may be lightweight and implemented using local compute resources that may be available at a rigsite. As an example, a lightweight ML model framework may be utilized for local implementation, optionally in an Internet of Things (IoT) environment. In such an example, local resources may be in communication with cloud-based resources, for example, to receive ML model updates, to transmit outputs, etc. As an example, a ML model may be implemented in a closed feedback loop data flow architecture where, for example, one or more sensors can transmit information to a cloud platform and where local equipment receives information from the cloud platform. In such an example, a trained ML model (e.g., local or remote) can provide predictions where such predictions are used in drilling operations and where data acquired during such operations are transmitted to the cloud platform, where they may be utilized for training, re-training, etc.

As mentioned, one or more machine learning techniques may be utilized to enhance planning, field operations, etc. As explained, various types of information can be generated via operations where such information may be utilized for training one or more types of machine learning models to generate one or more trained machine learning models, which may be deployed within one or more frameworks, environments, etc.

As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). Multiple platform support, covering ANDROID and iOS devices, embedded LINUX, and microcontrollers. Diverse language support, which includes JAVA, SWIFT, Objective-C, C++, and PYTHON. High performance, with hardware acceleration and model optimization. Machine learning tasks may include, for example, image classification, object detection, pose estimation, question answering, text classification, etc., on multiple platforms.

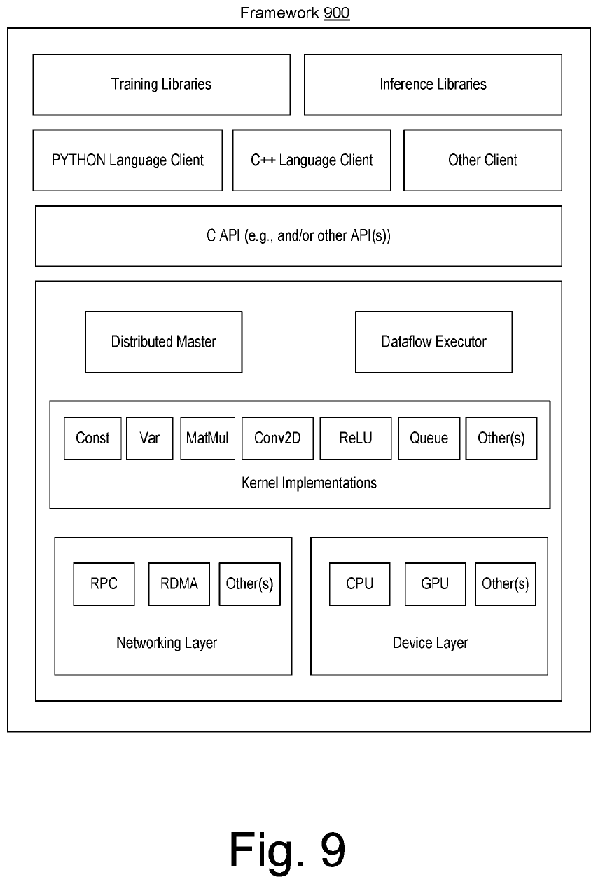

FIG. 9 shows an architecture 900 of a framework such as the TENSORFLOW framework. As shown, the architecture 900 includes various features. As an example, in the terminology of the architecture 900, a client can define a computation as a dataflow graph and, for example, can initiate graph execution using a session. As an example, a distributed master can prune a specific subgraph from the graph, as defined by the arguments to “Session.run( )”; partition the subgraph into multiple pieces that run in different processes and devices; distributes the graph pieces to worker services; and initiate graph piece execution by worker services. As to worker services (e.g., one per task), as an example, they may schedule the execution of graph operations using kernel implementations appropriate to hardware available (CPUs, GPUs, etc.) and, for example, send and receive operation results to and from other worker services. As to kernel implementations, these may, for example, perform computations for individual graph operations.

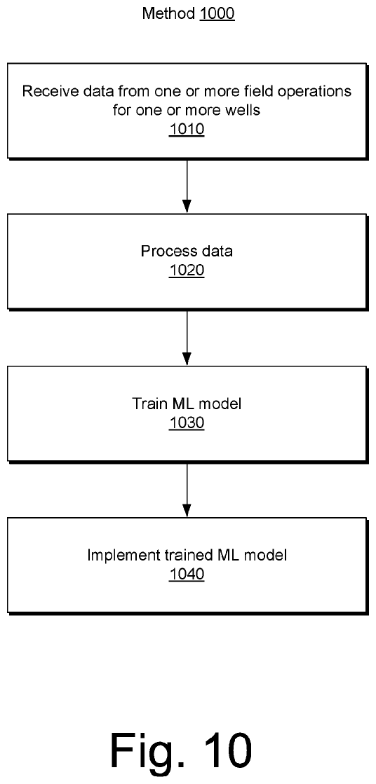

FIG. 10 shows an example of a method 1000 that includes a reception block 1010 for receiving data from one or more field operations for one or more wells, a process block 1020 for processing at least a portion of the data, a train block 1030 for training a ML model to generate a trained ML model and an implementation block 1040 for implementing the trained ML model.

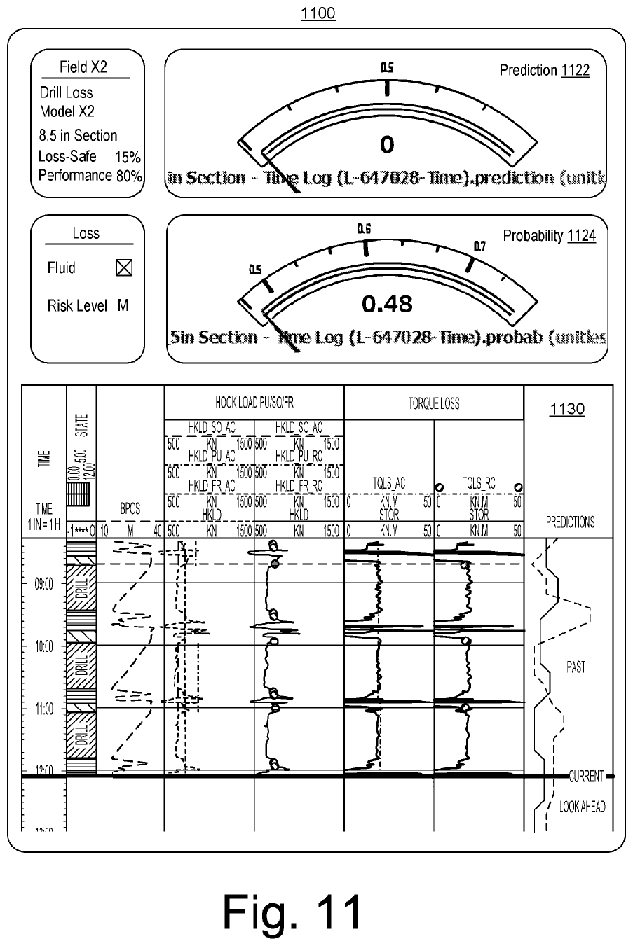

FIG. 11 shows an example of a graphical user interface (GUI) 1100 that can be rendered to a display of a device or devices via information output by a trained ML model. In the example of FIG. 11, the GUI 1100 includes panels 1122 and 1124 for predictions and probabilities of predictions, respectively. Such outputs can pertain to a particular section of a well that is being drilled (see, e.g., 8.5 inch section). As shown, the ML model may be trained for a particular field (see, e.g., Field X2). The GUI 1100 may include log information (e.g., channels) that pertains various drilling operations such as, for example, time, rig and/or drilling state, block position (BPOS), hook load (HKLD) for pickup (PU), slack off (SO) and free rotate (FR), torque loss (TQLS), surface torque (STOR), etc. Where a drillstring includes one or more sensors (e.g., LWD, MWD, etc.), one or more logs may include information from such downhole sensors. In the example of FIG. 11, a predictions log 1130 is shown as including values for past drilling operations, current drilling operations and future drilling operations (e.g., look ahead).

As explained, predictions can be made by a trained ML model where such predictions can be utilized for taking one or more actions during drilling operations. In the example of FIG. 11, the drilling operations include various drill states where block position (BPOS) is decreasing such that rock is being broken by a drill bit of a drillstring. As explained, drilling fluid (e.g., mud) can be utilized for one or more purposes such as to carry broken rock to surface, to lubricate the drillstring, to rotate a mud motor, to communicate via mud-pulse telemetry, etc. Where losses are predicted to be experienced, a GUI such as the GUI 1100 can render appropriate information that may help to reduce losses and/or consequences thereof. For example, an action can be suggested that reduces a loss and/or that mitigates an impact of the loss, whether reduced or not. Such an action may pertain to one or more of the parameters shown in the example of FIG. 11 and/or one or more other parameters. For example, consider weight on bit (WOB), RPM, mud flow rate, mud density, etc.

As to the example panels 1122 and 1124, for the indicated time (e.g., time log L-647028), a prediction can be indicated numerically and/or via a gauge per the panel 1122 where the panel 1124 can provide a corresponding probability for the prediction at the particular time. As explained, the prediction time can run ahead of a current time. In the example of FIG. 11, the prediction is indicated to be zero on a unit-less scale (e.g., from 0 to 1 or other scale, optionally binary) where the probability is indicated to be 0.48 on a unit-less scale (e.g., from 0 to 1 or other scale).

In the example panel 1122, one or more approaches may be taken with respect to the prediction value. For example, it may be the output of a trained ML model (e.g., from a softmax component or softmax function) where, for example, the probability may also be generated (e.g., from a softmax component or softmax function). As an example, in the example panel 1122, the numerical value of the prediction may be based on how soon an event may occur. For example, for a value of 1, the event may be predicted to occur at the time indicated; whereas, for a value of 0.5, the predicted event may be a number of time increments into the future. While time is mentioned, such an approach may be utilized, for example, with respect to block position (BPOS), which may correspond to stand length. For example, consider a stand as being approximately 30 meters in length where, for a given rate of penetration (ROP), a time can be associated with a particular length along the stand. In such an example, if the stand is 20 percent drilled (e.g., 6 meters drilled), a prediction may correspond to the next 20 percent (e.g., the next 6 meters) or one or more 20 percent intervals into the future (e.g., 6 meter intervals) where a ROP can be utilized to know when such one or more intervals may be expected.

In the example of FIG. 11, the predictions log 1130 can include more than one type of prediction. For example, consider a loss due to one factor and a loss due to another factor. In such an example, one or more trained ML models may be utilized where, for example, the first factor corresponds to a first type of data and the second factor corresponds to a second type of data. In such an example, a first trained ML model may identify a pattern in the first type of data to make a prediction and the second trained ML model may identify a pattern in the second type of data to make a prediction. In such an example, actions may differ for the two predictions such that the GUI 1100 may issue a notification and/or a control signal that differs based on which trained ML model is making the prediction.

As noted with respect to the method 1000 of FIG. 10, a method can include processing data. As explained, as drilling occurs, data can stream from field equipment (e.g., sensors, etc.) to a collection unit in a cloud platform. Such data can be processed, for example, such that it is cleaned, formatted, etc., for used as input to a ML framework. The data may come from wells from a common field as a target well, which may allow for creation of a trained ML model that is localized and particularly suited to a particular field or region. As an example, data may be collected from one or more fields with similar and/or common characteristics as a field of a target well (e.g., regardless of where the fields are physically located).

As explained, a system can provide for issuance of proactive alarms, control signals, etc., using machine learning, including deep learning, to predict downhole losses proactively. Such an approach can give an operator and/or an operations team ample time to take one or more preventive measures. A system may operate to predict, prevent and mitigate severity of downhole losses while drilling. Such an approach can allow for improved performance compared to a reactive system where an alarm is issued after a loss starts (e.g., a system with an inability to prevent a loss). Further, systems with proactive alarm that operate according to hard unchanging rules set by a human, lack adaptability (e.g., customization, ability to learn, etc.), tend to be error prone and may not recognize particular patterns that can be indicative of a loss or losses.

As an example, a system may utilize one or more recurrent neural networks (RNNs). One type of RNN is referred to as long short-term memory (LSTM), which can be a unit or component (e.g., of one or more units) that can be in a layer or layers. A LSTM component can be a type of artificial neural network (ANN) designed to recognize patterns in sequences of data, such as times series data. When provided with time series data, LSTMs take time and sequence into account such that an LSTM can include a temporal dimension.

As explained, a system can utilize a ML model-based approach to predict one or more types of downhole problems. Such a system may be customized for a particular field, operating company, equipment, etc. As an example, a system can leverage deep learning long short-term memory (LSTM) layer components, which may be optimized for geographic location, specific drilling problems, etc. A system may be a customized system that can generate customized proactive alarms for losses at one or more drilling sites.

As explained with respect to the method 1000 of FIG. 10, data can be received and processed followed by use of at least a portion of the data (e.g., processed and/or unprocessed) for model training. As explained, a ML model can include LSTM layer components where training thereof provides for generation of a trained ML model that can predict one or more types of losses, which may be utilized as a basis for issuance of alarms, control signals, etc. Such a method may also provide for recommending and/or issuing signals for taking operational preventive measures.

In machine learning, feature engineering can provide for defining particular features that are relevant to an ability to make predictions. For example, to capture the physics of drilling activity along with mathematical transformations, in various trials, the following features were utilized
Well-related features: mud properties, LOT, formation susceptibility, formation tops, sub activities based on data like drilling, RIH, etc.
Time-based features: breaking down time for shift (e.g., day/night) to capture crew dynamics.
Lagged features: lagged parameters to capture lagged response in loss.
Rolling window: rolling averages for last 1 min, 2 mins, 5 and 10; sum, min, max, STD; weighted average giving higher weights to recent parameter values; expanding feature window to capture certain dynamics of a parameter (e.g., utilizing ranking as to influence, etc.).
Mathematical transformation(s): log transform, periodic difference, squares and square roots, physics behind parametric values, binning.

As an example, relationships of variables with respect to one or more upcoming losses may be assessed. For example, consider flagging variables in association with losses using one or more techniques where such data may be utilized for training, testing, ML model selection, ML model optimization, etc.

As an example, a method can include dividing input parameters into categories to assess dependencies of variable sets to losses, which may reveal deeper relationships between variables and one or more losses. In such an example, consider one or more of the following categories: parameters that are related to mud amount as indicating reactivity of a model; drilling parameters that may indicate losses based on drilling practices and their weightage in wells considered; and depth parameters that can provide for exploration of formation proxies that may indicate parameters leading to fracture induced losses.

As an example, volume related variables such as pit volumes, active volume, flow paddles, etc., may be removed in various instances to help ensure that a trained ML model is more proactive rather than reactive (e.g., as volume variables tend to reactively indicate when mud is lost).

As an example, a decision tree model can be trained without volume variables to assess variable that can then be utilized for purposes of training a ML model or ML models for purposes of loss prediction. For example, consider using a decision tree model with a maximum tree depth of 4 nodes with 3 minimum samples per leaf node and optimized over a Gini index, where the Gini index or Gini impurity, calculates the amount of probability of a specific feature that is classified incorrectly when selected randomly. In such an approach, variables were ranked as follows, from higher to lower: standpipe pressure (SPPA), depth (DEPT), block position (BPOS), flow rate (FLWI), and hook load (HKLD). The foregoing approach may not explain the full picture of the variable complexity yet it provides insight into certain relationships which other more sophisticated models (e.g., ANNs, etc.) can explore for purposes of predictions. Such an approach also indicated that losses may occur due to drilling practices (e.g., high SPPA leading to formation fracture); noting that depth is also a highly ranked variable (parameter), which indicates that a formation at certain depths can be more susceptible to losses.

As explained with respect to the GUI 1100 of FIG. 11, one or more logs of variables (parameters) may be presented along with a prediction log (e.g., and/or probability log) for one or more types of losses where the prediction log can run in advance of a current time by a desired amount of time (e.g., a look ahead period).

In various examples a resampling approach was utilized for training such as a 75-25 approach. In such an approach, as time series data for an event may be highly unbalanced, rebalancing of data can be performed for feeding the data into a training framework. For example, over sampling of loss event time frames and under sampling of no-loss events can be performed to create a relatively balanced ratio of 75 (no loss time stamps) and 25 (loss time stamps).

As to sequence length, consider utilization of a sequence length of approximately 2000. In such an approach, 2000 time stamps (e.g., approximately 3 hours of surface data parameters) can be used to feed into a LSTM-based model for a prediction, which is at the end time frame as part of a deep neural network that is being trained.

As to batch size, consider a batch size of approximately 64. In such an approach, a batch size of 64 can be considered “medium” sized batches for use in deep learning.

As to epochs, one or more epochs may be utilized. For example, consider use of a single epoch. In such an example, the single epoch approach granted a good balance between precision and recall and comparable efficiencies in validation and training dataset, which helped to ensured robustness.

As to layers, consider an architecture that includes four layers (e.g., two LSTM and one or two dense layers) as being part of a deep neural network architecture.

As to a solver, consider implementation of the Adam solver, which can be implemented to solve for parameters with a learning rate of approximately 0.01 and a decay of approximately 1 e-5. The Adam solver can provide benefits of two other extensions of stochastic gradient descent, known as Adaptive Gradient Algorithm (AdaGrad) and Root Mean Square Propagation (RMSProp) where AdaGrad maintains a per-parameter learning rate that improves performance on problems with sparse gradients (e.g. natural language and computer vision problems) and where RMSProp also maintains per-parameter learning rates that are adapted based on the average of recent magnitudes of the gradients for the weight (e.g. how quickly it is changing), which helps in solving online and non-stationary problems (e.g. noisy). Adam, instead of adapting the parameter learning rates based on the average first moment (the mean) as in RMSProp, it also makes use of the average of the second moments of the gradients (e.g., the uncentered variance). Specifically, the algorithm calculates an exponential moving average of the gradient and the squared gradient, where parameters (e.g., beta1 and beta2) control the decay rates of these moving averages. While Adam is mentioned, one or more other solvers may be utilized.

As explained, a system can utilize particular feature engineering for physics-based training data features (e.g., rather than simple surface/mud data) to help captures loss signatures beyond surface parameters; can include rig state feature, for example, considering torque during drilling differently than torque during wash up and ream down (e.g., where the former is informative as to torque in a drillstring during drilling while the latter is informative as to hole condition) such that a trained ML model is smarter and more wholesome in capturing actual dynamics of the drilling activity; can utilize a LSTM-based model with a sufficiently sized sequence length to help provide for detection of time series trends (e.g., rather than current state based prediction as tends to be the case with machine learning models such as regression, neural networks, random forest, support vector machines (SVMs), etc., where the LSTM-based model is fed with a multidimensional vector (e.g., 3D vector) of dimensions [Batch Size, Sequence Length, Input Dimensions] from which LSTM weights “pick” information to make sense of past data, which provides for making better predictions as compared to various other ML model approaches; and can provide an optimized LSTM deep learning model (e.g., a LSTM-based DL model), which can be looped over hyper parameters, architecture, solvers, regularization and where data transformations (e.g., with over and under samplings, algorithm architecture tweaked as training proceeded on different wells, threshold probability increased to preserve true event alarms, etc.), where various techniques can provide for tailoring of computational and data demands.

As explained, a ML model can utilize a hierarchy of LSTM layer components, which may be included in series (e.g., a chain) for predictions based on time series data.

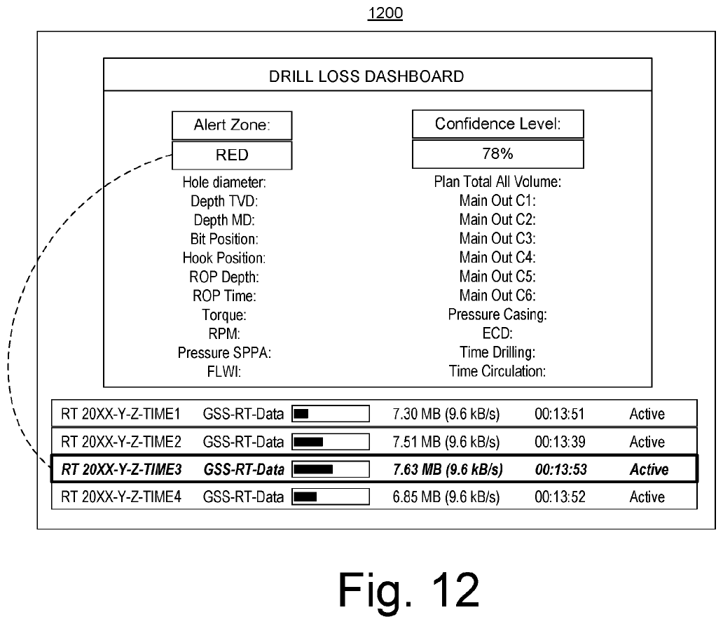

FIG. 12 shows an example of a GUI 1200 that includes panels that may be utilized as an alternative to one or more of the panels of the GUI 1100 and/or in addition to one or more of the panels of the GUI 1100. As shown in FIG. 12, the GUI 1200 can include pop-up graphics, for example, to indicate a risk zone along with prediction confidence. In such an approach, the GUI 1200 can showcase parameters causing a risk level(s) to rise. In the example GUI 1200, one or more frameworks (e.g., TECHLOG, WELLSYNC, etc.) may be utilized to provide real-time data (e.g., to download and/or stream data in real time to a ML model-based system).

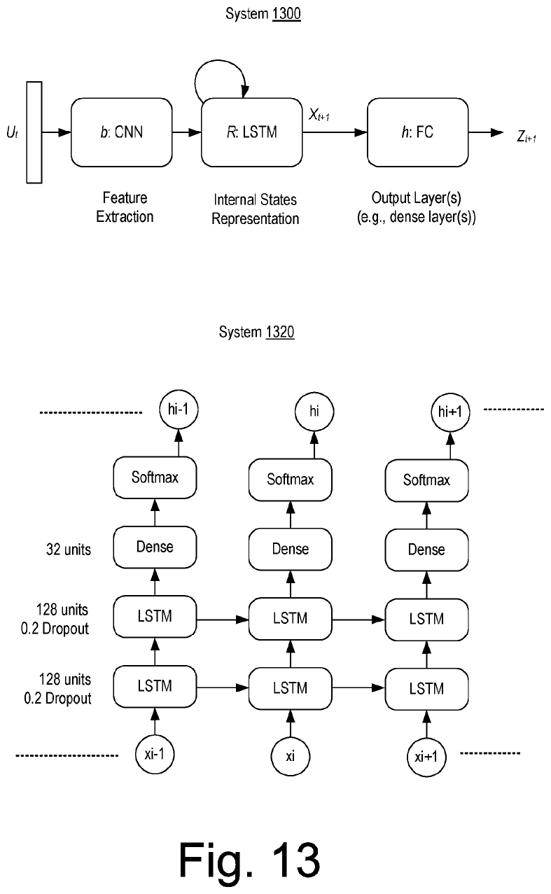

FIG. 13 shows an example of a system 1300 and an example of a portion of a system 1320, where each of the systems 1300 and 1320 can be described as having an architecture. As shown in the system 1300, an input vector Uₜ can be a time-windowed multiple channels while the output can be a response, which may be a prediction. In the example system 1300, the transfer function b is provided via a convolution neural network (CNN) that can perform feature extraction that is received by a long short-term memory (LSTM) layer component that can provide for internal states representation, for example, in a latent space (e.g., a feature space). Output of the LSTM component can be received by a function h, which can include a fully-connected (FC) layer component, which can be referred to as a dense layer. Where LSTM is mentioned, it may be a forget gate (fg) LSTM. Such an LSTM can “forget” certain parameter values as may be appropriate to model temporal behavior of a “plant” (e.g., equipment and environment).

As to the system 1320, it includes a different architecture, particularly with respect to the utilization of LSTM layer components (e.g., RNN components or units). As shown, the LSTM architecture includes instances of two LSTM layers followed by a dense layer (e.g., fully-connected (FC)) followed by a softmax to make the ML model capable of decoupling failure precursors while also being computationally efficient, which provides for real-time performance as the trained ML model can be implemented in real-time while performing field operations (e.g., with a refresh rate of less than approximately 1 sec (e.g., approximately 1 Hz or less)).

As shown in the example of FIG. 13, each output takes three inputs, the vector input xi which can be of dimensions [sequence length, #features], inputs from the first LSTM layer of previous prediction and input from the second LSTM layer of previous prediction. As shown, the chain of fed information from LSTMs helps to retain past data for more meaningful predictions as drilling failures like losses tend to be primarily driven from what has happened in past (e.g., past conditions, past states, etc.).

In the example of FIG. 13, the LSTM layers are shown as indicating a number of units (e.g., 128 units) and dropout (e.g., 0.2), where dropout is a regularization method where input and recurrent connections to LSTM units are probabilistically excluded from activation and weight updates while training a network. Such an approach can be based on trials (e.g., as to number of units, dropout, etc.) and can have the effect of reducing overfitting and improving model performance. In the example of FIG. 13, the dense layer is shown as indicating a number of units (e.g., 32 units).

In the example of system 1320, the softmax component (e.g., softmax function) can take as input a vector of real numbers and normalizes it into a probability distribution consisting of a number of probabilities proportional to the exponentials of the input numbers. For example, prior to applying the softmax function, some vector components could be negative, or greater than one; and might not sum to 1; but after applying the softmax function, each vector component will be in the interval (0,1) and the vector components will sum to 1 so that they can be interpreted as probabilities. In such an example, the larger input vector components will generally correspond to larger probabilities.

In a LSTM-based approach, historic data can be weighted appropriately such that a prediction can be made using at least a portion of the historic data (e.g., as appropriately weighted). The utilization of multiple LSTM components in a successive manner (e.g., as vertically stacked in the example system 1320 of FIG. 13) can help to decouple complexities in time series data. As an example, the number of LSTM components may be increased to more than two though with increased demands for training, etc.

As shown in the example system 1320, each LSTM component can receive two inputs. For example, the first LSTM component can receive a vector (e.g., xi) and output from a prior instance of the first LSTM for a prior vector (e.g., xi-1); whereas, the second LSTM component can receive the processed vector (e.g., xi as processed by the first LSTM component) and output from a prior instance of the second LSTM. In operation in real-time, a trained recurrent neural network model can receive a vector of data (e.g., optionally processed) where the trained recurrent neural network model can output a prediction or predictions. As explained, channels of real-time time series data can be received where historic data are accounted for via structures like LSTM components (e.g., recurrent neural networks) where signatures in the data can be identified as being associated with one or more types of issues.

In various trials, two successive LSTM components demonstrated suitable results in making predictions with suitable computational demands. As to complexities in time series data, a signature of a problem may be, from less complex to more complex: dependent on a standard deviation of a single channel; dependent on a mean of one channel and a standard deviation of another channel; a value of one channel, a mean of another channel and a standard deviation of yet another channel; a cluster of means of multiple channels; etc. As an example, where 72 channels of time series data are utilized, the number of combinations of values and/or metrics of such channels can be complex.

As an example, a system may include various components where, for example, the components include RNN components such as LSTM components. As explained with respect to FIG. 13, one or more LSTM components can be utilized in a model architecture that may be fronted (e.g., fed by) another ML model or be fed by data such as processed data. As explained, one or more LSTM components can provide output to an LSTM component and/or to another type of component (e.g., consider the dense components, etc.).

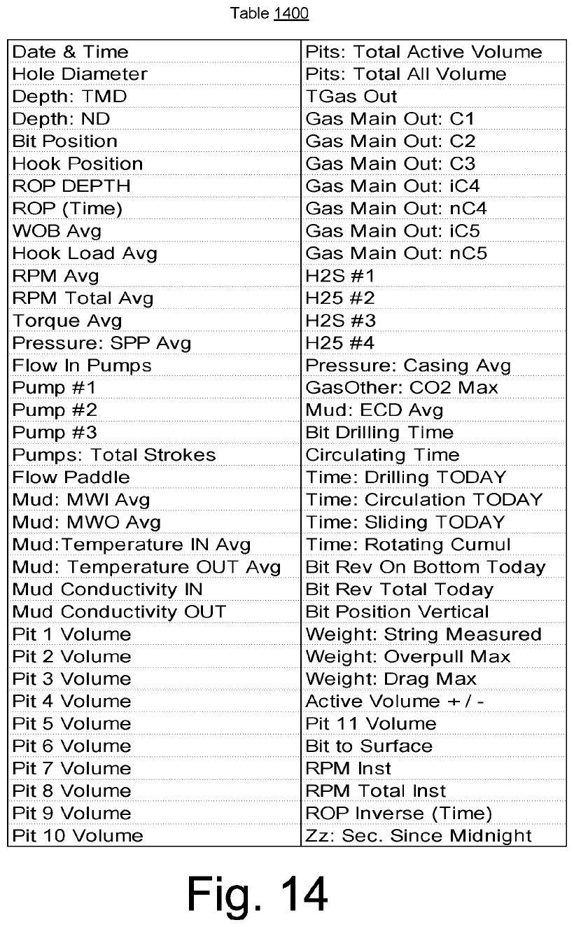

FIG. 14 shows an example table 1400 of various factors or inputs, which may be referred to as features. The table 1400 shows 72 features, which may be utilized as inputs. As explained, a method can include processing data that can, for example, perform quality checks on the data, which may provide for adjustments to data (e.g., for sensor malfunctions, calibration issues, etc.). Such an approach may provide for removing outliers and hand-fed values.

As explained, a method can include accounting for balance. In certain situations, the data sets may be highly imbalanced as events to be detected may be infrequent (e.g., rare) in various data sets. As explained, one or more techniques may be applied to account for balance. For example, consider an approach that acts to over-sample rare loss events, under-sample no-loss events, utilize Z-scores, feature scaling, replacement of missing data (e.g., with modes, median, mean, etc.), utilization of rolling average values to suppress data shocks, and/or principle component analysis (PCA).

As to PCA, it may be utilized for linear dimensionality reduction. For example, consider implementing a PCA technique to find orthogonal bases (e.g., principal components/eigenvectors) that preserve the largest variance of given data. Such an approach may be referred to as a feature extraction technique where instead of selecting subset of features to reduce dimensions it projects data into different bases. As explained, PCA may be implemented to reduce the number of linear combinations of input data that explain most of the variability.

As an example, an approach may segment time series data into intervals. For example, consider using 5 second intervals. Such data may be processed then be input to an appropriate algorithm for training and/or for use in operation of an online ML model-based system. Data processing may occur locally at the rig site, using a cloud platform, a combination of local/remote, etc. As an example, forced values and/or outliers may be removed from data.

As explained, feature engineering can be performed in a manner that aims to promote an ability to identify patterns in data. For example, features may be created to capture physics of hydraulic hammer effect and cutting loading. Such effects may be characterized using mathematical transformations (e.g., mean, standard deviation, etc.).

As to utilization of data, it may be fed into a trained ML model to detect possible upcoming loss events (e.g., using current parameters, etc.). In various example trials, ML models were trained using 25 offset wells for loss and no loss situations. In such examples, trends captured over time can be triggered when a well is being drilled with similar parameters in a similar formation.

As an example, a system can be tailored by training a ML model or ML models to identify downhole problems for a certain period of time before occurrence of the problem. For example, consider an approach that utilizes a look ahead period that is approximately 10 minutes such that an operator, operational team, controller, etc., can assess and/or take one or more actions (e.g., to prevent, mitigate, etc.). As an example, a ML model may be trained using a desirable look ahead period. As explained with respect to the GUI 1100 of FIG. 11, a log approach may be utilized to present values in a look ahead period that runs in advance of real-time data (e.g., current time) for a well being drilled. While various examples pertain to problems like lost circulation, one or more ML models may be trained to detect one or more other types of problems, additionally or alternatively. For example, consider detection of problems like kick, stuck pipe, etc.

As to various types of ML models, consider utilizing one or more of ANNs; random forests; K-nearest neighbors (KNN); AdaBoost; and XGBoost. ANNs generally work well with non-linear data, have good tolerance of faults and can work with incomplete knowledge. In certain embodiments, an ANN may be suitable for the use case of drilling where the data are susceptible to errors. As to random forest, AdaBoost, and XGboost, these are tree-based classifiers, which can be visualized relatively easily and have strong prediction power. As to KNN, it can be relatively easy to visualize and can give insights in the data and prediction.

As an example, an ensemble approach may be implemented where more than one ML model is utilized and where outputs (e.g., predictions) from such ML models can be compared. As an example, comparisons may be based in part on performance of ML models where performance may be measured in terms of one or more of accuracy, precision and recall. An analysis of such measures may balance the ability of a ML model or ML modes to predict loss events with an acceptable rate of false alarms generated.

In various example trials, an approach involved training ML models on well data for already drilled wells to predict losses 10 minutes before a loss event occurred. Ten minutes may be selected as an appropriate time as it may provide sufficient time to take one or more preventative and/or mitigation actions. ML model success may be based on how early the ML model predicts the loss and the loss rate. As an example, a trained ML model can issue an alarm, a control signal, etc., when it predicts an upcoming loss. As explained, a ML model may be utilized in a planning phase where, for example, a plan well can be designed to provide for taking of preventative measures that can be quick to apply (e.g., in under 10 minutes).

As to some examples of operational actions, consider an alarm being raised such that ROP is reduced (e.g., manually or automatically via a controller) and where equivalent circulating density (ECDs) are checked, borehole condition is monitored, and inspection occurs as to active volume to look for leaks in a drilling fluid (mud) circulatory system (e.g., manually and/or automatically via a controller or controllers). In such an example, the reduction in ROP can reduce energy input, which can result in reduced ECD spikes, which can be a measure against induced losses.

In a planning phase, one or more drilling practices can be adjusted in such a manner that ECDs are in check and an alarm does not go off when the well is simulated prior to drilling (e.g., using a drilling simulator framework, etc.). One or more measures may include slowing ROP, lowering flowrates, improving rheology, lessening surge, etc. As an example, multiple measures may be applied to reduce the likelihood and severity of a loss event.

TABLE 1
Results achieved for some example ML models.

| Algorithm | Prediction Efficiency | Remarks |
|---|---|---|
| Neural Networks | 95.53% | Best balance. |
| XGBoost | 99.37% | Predicts just before |
| | | event/missed event |
| AdaBoost | 72.83% | Predicts the problem, but too |
| | | many false alarms. |
| Random Forest | 99.37% | Predicts just before |
| | | event/misses event |
| K-Neighbor | 99.37% | Predicts just before |
| | | event/misses event |

The ML models results of Table 1 were generated using the same data. In the example trials, the ML models learn from the last 4 wells that experience loss circulation and predict the loss 10 minutes before. As indicated above, random forest, XGBoost and KNN either fail to detect an event or detect the event less than two minutes before it occurs. In the example trials, AdaBoost provided false alarms but predicted the losses at the appropriate time.

From the results of Table 1, ANNs tend to have the best balance of true prediction rates and false. The example ANN predicted the problem and also reduced false alarms to trigger only about 68 minutes over 2 days.

TABLE 2
Confusion matrix for ANN in scenarios.

| True Class/Predicted | Predicted No-Loss | Predicted-Loss |
|---|---|---|
| Class | Situation | Situation |
| True No-Loss Situation | 18199 | 817 |
| False No-Loss Situation | 38 | 82 |

In the examples of Table 1, the ANN may be considered suitable given its ability to provide high accuracy, where threshold adjustments may be made in implementation as to output of predictions (e.g., to reduce false, etc.).

In a planning phase, planned ranges of parameters can be fed into a system with corresponding depths to see raised alarms, as appropriate. In such an example, if the system raises an alarm with the planned parameters it may indicate that the planned parameters can be adjusted to increase the likelihood of lossless drilling. As an example, a system may be used to differentiate between loss wells and no loss wells and loss precursors. As an example, loss signatures may be different for different activities such as drilling, tripping, and cementing.

In an execution phase, a system may provide for real-time monitoring and/or control. In such an approach, one or more drilling parameters may be adjusted upon receiving an alarm to ensure lower ECDs and prevention of induced fractures and associated lost circulation. As explained, alarms and/or other information may be provided via a GUI or GUIs. Alarms may be provided using audible cues and/or visual cues. As explained, an alarm may be a notification issued by a system and transmitted to a device (e.g., a mobile device, a controller, etc.). As an example, a notification may be in the form of an email, text message, or notification in an application installed on a mobile device, a controller, etc.

As explained, a system can provide for issuance of forward-looking proactive alarms. As an example, a system may also provide for issuance of one or more reactive alarms that trigger in response to an event already having occurred. In such an example, a feedback mechanism may be provided such that data associated with reactive alarms that may not have been called for using a proactive approach can be utilized for training a ML model or ML models. As explained, a system can provide alarms that can be customized to a particular operation and/or field.

As explained, a combination of techniques may be used to implement proactive alarms, which may provide for issuance of proactive control signals. For example, feature engineering for physics-based training data features may be used additional to or alternative to simple surface/mud data. Such an approach can enable capturing loss signatures beyond surface parameters.

As explained, a system may utilize rig state features, for example, consider torque during drilling differently from torque during wash up and ream down as the former tells about the torque in the drillstring during drilling while the latter indicates borehole condition. Such an approach can provide for more accurate capture of actual dynamics of drilling activity.

As explained, a system can include one or more RNN-based ML models, which can include one or more LSTM components. As explained, a LSTM-based approach involved utilization of a 2000 sequence length (e.g., approximately 3 hours), as a hyperparameter, that provided for detection of time series trends. Such an approach may be optimized, as appropriate, for example, to account for different types of losses from different types of features in time series data and, optionally, other data. As LSTM can be “short-term” in terms of memory, a sequence length of 20000 may be overly long (e.g., approximately 30 hours) in the context of drill loss prediction. As explained, a ML model may be a LSTM deep learning (DL) model. As to optimization, consider an approach that may loop over hyper parameters, architecture, solvers, and regularization. As explained, data transformations may be executed with over and under samplings, an architecture tweaked as training proceeds on different wells, for example, with threshold probability increased to preserve true event alarms. As an example, one or more thresholds may be utilized to control predictions to provide for output of desirable predictions.

As explained, a trained ML model can provide for relatively rare event detection as loss events may happen once/twice while drilling entire section of a well. As an example, sensor data fed to a ML model can be scaled and processed (e.g., using PCA) in a manner that may act to reduce dimensionality (e.g., a linear dimensionality reduction) of the input data. As explained, for training, a combination of oversampling of minority and under sampling of majority class may be implemented to handle unbalanced historic data. An optimization process can involve looping over hyperparameters and threshold probability where hyperparameter selection can aim to provide a maximum AUC-ROC (area under the curve (AUC) and receiver operating characteristics (ROC)). In various example trials, a ML model demonstrated accuracy of 95 percent. A system utilizing such a ML model was implemented in a field where a percentage of the wells suffered from downhole losses. In the example trial, after implementation of the system, wells were drilled successfully without encountering losses, thereby saving cost of lost mud, lost circulation material (LCM) saved, associated rig NPT, visible and invisible cost of poor cement job, etc.

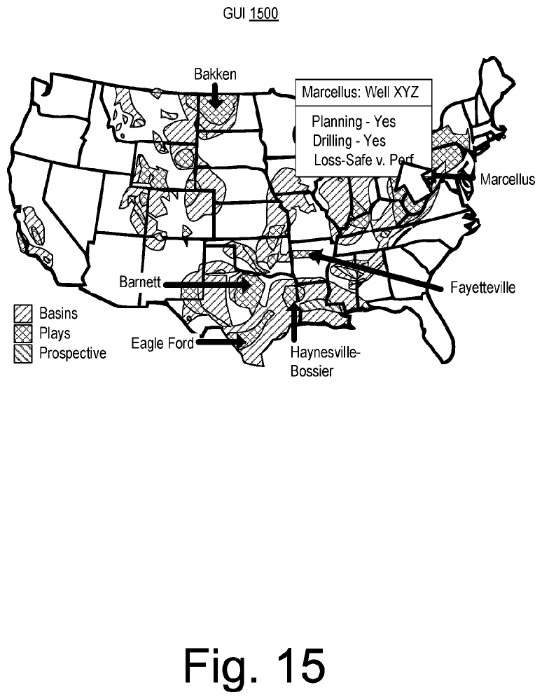

FIG. 15 shows an example of a GUI 1500 that includes a graphic for a well XYZ in the Marcellus region. As shown, the graphic indicates that a ML model was utilized during planning of the well to reduce losses and that a ML model is to be utilized or is being utilizes during drilling of at least a portion of the well XYZ. Further, the graphic indicates that drilling practices can be selected from loss-safe and performance practices. As indicated, where a trained ML model predicts a loss event prior to actual occurrence of the loss event, a system may issue a signal that indicates that drilling practices can be switched, for example, from a performance practice to a loss-safe practice. Such an approach to practice switching in real-time responsive to prediction of one or more types of loss events can provide for a reduction in occurrence of loss events and/or consequences thereof, if a loss event does occur.

In the example of FIG. 15, the GUI 1500 may provide for selection of a ML model that is customized to one or more of the indicated regions (e.g., basins, plays, prospects, etc.). As an example, one or more ML models can be trained using data from one or more regions, one or more proxies, etc., where one or more trained ML models can then be selected as appropriate for planning and/or field operations to reduce losses.

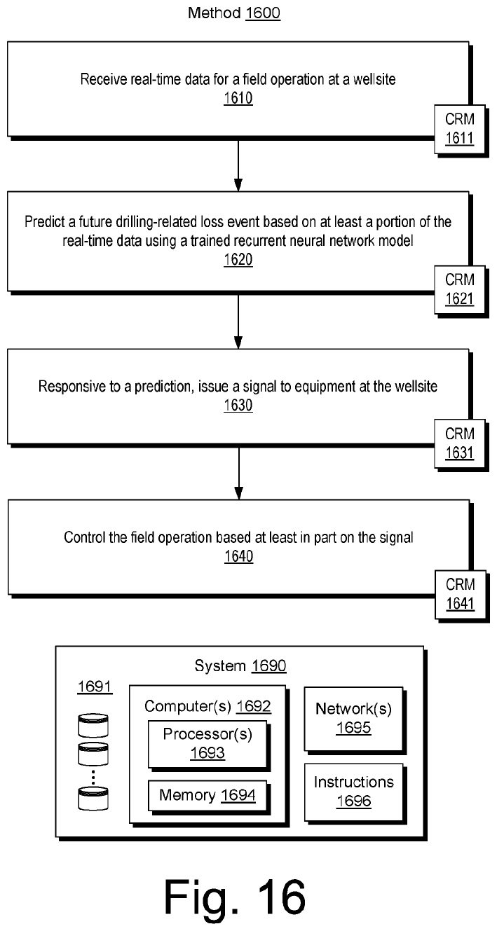

FIG. 16 shows an example of a method 1600 and an example of a system 1690. As shown, the method 1600 includes a reception block 1610 for receiving real-time data for a field operation at a wellsite; a prediction block 1620 for predicting a future drilling-related loss event based on at least a portion of the real-time data using a trained recurrent neural network model; and an issuance block 1630 for, responsive to the predicting, issuing a signal to equipment at the wellsite. As shown, the method 1600 can include a control block 1640 for controlling the field operation at the wellsite based at least in part on the signal.

The method 1600 is shown as including various computer-readable storage medium (CRM) blocks 1611, 1621, 1631 and 1641 that can include processor-executable instructions that can instruct a computing system, which can be a control system, to perform one or more of the actions described with respect to the method 1600.

In the example of FIG. 16, the system 1690 includes one or more information storage devices 1691, one or more computers 1692, one or more networks 1695 and instructions 1696. As to the one or more computers 1692, each computer may include one or more processors (e.g., or processing cores) 1693 and memory 1694 for storing the instructions 1696, for example, executable by at least one of the one or more processors 1693 (see, e.g., the blocks 1611, 1621, 1631 and 1641). As an example, a computer may include one or more network interfaces (e.g., wired or wireless), one or more graphics cards, a display interface (e.g., wired or wireless), etc.

As an example, the method 1600 may be a workflow that can be implemented using one or more frameworks that may be within a framework environment. As an example, the system 1690 can include local and/or remote resources. For example, consider a browser application executing on a client device as being a local resource with respect to a user of the browser application and a cloud-based computing device as being a remote resources with respect to the user. In such an example, the user may interact with the client device via the browser application where information is transmitted to the cloud-based computing device (or devices) and where information may be received in response and rendered to a display operatively coupled to the client device (e.g., via services, APIs, etc.).

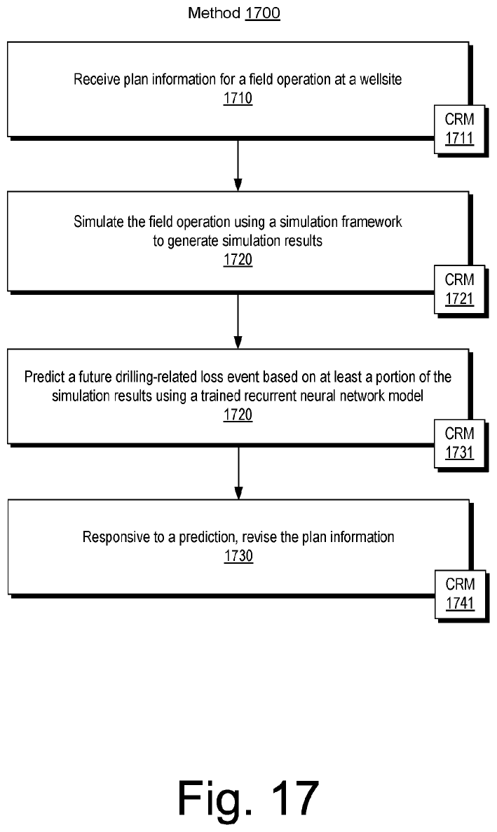

FIG. 17 shows an example of a method 1700 that includes a reception block 1710 for receiving plan information for a field operation at a wellsite; a simulation block 1720 for simulating the field operation using a simulation framework to generate simulation results; a prediction block 1730 for predicting a future drilling-related loss event based on at least a portion of the simulation results using a trained recurrent neural network model; and a revision block 1740 for, responsive to a prediction, revising the plan information. As explained, such a method can provide for generate of plan information (e.g., a digital well plan, etc.) for one or more field operations at a wellsite where a reduction in drilling-related loss events may be realized. As an example, the method 1700 may be iterative and handle a series of field operations such as, for example, field operations for drilling one or more sections of a well.

The method 1700 is shown as including various computer-readable storage medium (CRM) blocks 1711, 1721, 1731 and 1741 that can include processor-executable instructions that can instruct a computing system, which can be a control system, to perform one or more of the actions described with respect to the method 1700. Such CRM blocks may be provided as instructions such as the instructions 1696 of the system 1690 of FIG. 16.

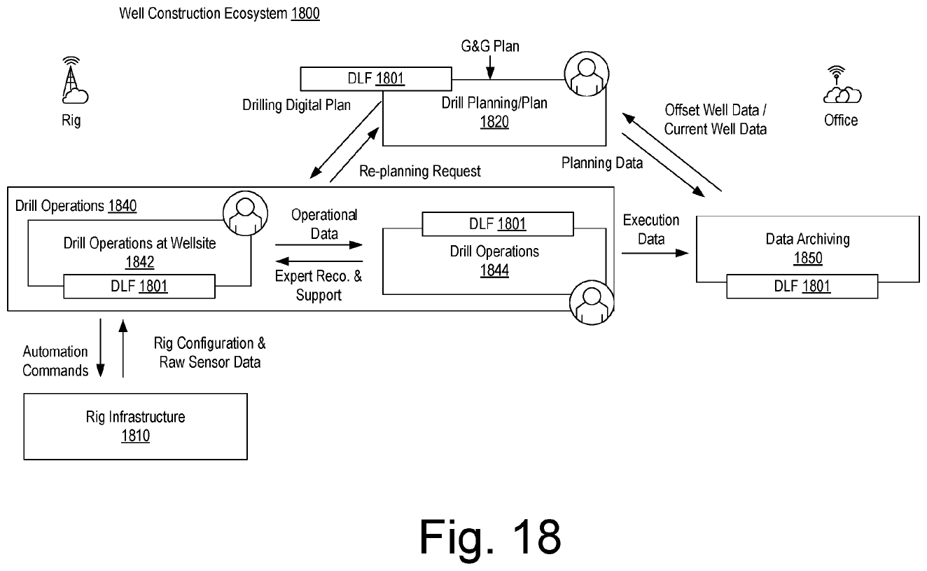

FIG. 18 shows an example of a system 1800 that can be a well construction ecosystem. As shown, the system 1800 can include one or more instances of a drill loss framework (DLF) 1801 (see, e.g., FIG. 8, etc.) and can include a rig infrastructure 1810 and a drill plan component 1820 that can generation or otherwise transmit information associated with a plan to be executed utilizing the rig infrastructure 1810, for example, via a drilling operations layer 1840, which includes a wellsite component 1842 and an offsite component 1844. As shown, data acquired and/or generated by the drilling operations layer 1840 can be transmitted to a data archiving component 1850, which may be utilized, for example, for purposes of planning one or more operations (e.g., per the drilling plan component 1820).

In the example of FIG. 18, the DLF 1801 is shown as being implemented with respect to the drill plan component 1820, the wellsite component 1842 and/or the offsite component 1844.

As an example, the DLF 1801 can interact with one or more of the components in the system 1800. As shown, the DLF 1801 can be utilized in conjunction with the drill plan component 1820. In such an example, data accessed from the data archiving component 1850 may be utilized to assess output of the DLF 1801 or, for example, may be utilized as input to the DLF 1801. As an example, the data archiving component 1850 can include drilling data for one or more offset wells and/or one or more current wells pertaining to specifications for and/or operations of one or more types of bits, etc.

As shown in FIG. 18, various components of the drilling operations layer 1840 may utilize the DLF 1801 and/or a drilling digital plan as output by the drill plan component 1820. During drilling, execution data can be acquired, which may be utilized by the DLF 1801. Such execution data can be archived in the data archiving component 1850, which may be archived during one or more drill operations and may be available by the drill plan component 1820, for example, for re-planning, etc. As an example, the DLF 1801 may be utilized in conjunction with the data archiving component 1850 for purposes of training, re-training, testing, etc., of one or more ML models. As explained with respect to the GUI 1500 of FIG. 15, a ML model may be customized, for example, via training with data from a particular region; noting that one or more other types of criteria may be utilized to select data for training, for example, to provide for generation of a customize a trained ML model.

As an example, a method may be implemented in part using computer-readable media (CRM), for example, as a block, etc. that include information such as instructions suitable for execution by one or more processors (or processor cores) to instruct a computing device or system to perform one or more actions. As an example, a single medium may be configured with instructions to allow for, at least in part, performance of various actions of a method. As an example, a computer-readable medium (CRM) may be a computer-readable storage medium (e.g., a non-transitory medium) that is not a carrier wave.

According to an embodiment, one or more computer-readable media may include computer-executable instructions to instruct a computing system to output information for controlling a process. For example, such instructions may provide for output to sensing process, an injection process, drilling process, an extraction process, an extrusion process, a pumping process, a heating process, etc.

As an example, a method can include receiving real-time data for a field operation at a wellsite; predicting a future drilling-related loss event based on at least a portion of the real-time data using a trained recurrent neural network model; and, responsive to the predicting, issuing a signal to equipment at the wellsite. In such an example, the trained recurrent neural network model can include at least two successive long short-term memory components (LSTM components). In such an example, the utilization of successive LSTM components can help to generate a trained ML model that can account for various patterns in time series data where, for example, various patterns may include various time scales, frequencies, etc. Such an approach can help make a trained ML model more robust and/or accurate in making predictions using time series data of one or more channels.

As an example, a method can include predicting via providing at least a portion of real-time data to a trained recurrent neural network model as a vector and outputting a numerical value indicative of a future drilling-related loss event. In such an example, the method may include outputting a probability that corresponds to the numerical value indicative of the future drilling-related loss event. For example, consider applying a softmax function (e.g., a softmax component) to output from a dense layer (e.g., a fully-connected (FC) layer) that follows successive LSTM layer components that receive a vector where the vector includes values based on one or more channels of equipment data (e.g., sensor-based data, etc.).

As an example, a future drilling-related loss event can be a loss of circulation event. As an example, a future drilling-related loss event can be a kick event, a stuck pipe event, etc.

As an example, a signal issued by a method can include a reduction in energy input signal. For example, consider a reduction in energy input signal that is or includes a signal to reduce rate of penetration (ROP) of a field operation. As explained, one or more types of actions may be taken, which may be called for and/or implemented via one or more signals. As an example, an action or actions can include one or more of a drilling action, a drilling fluid characteristics (e.g., properties) action, a drilling fluid movement action, a drilling fluid solids removal action, etc.

As an example, a method can include processing real-time data using a dimensionality reduction technique. For example, consider implementing a linear technique such as a principal component analysis (PCA) technique; noting that a linear and/or a non-linear technique may be implemented.

As an example, real-time data can include one or more of standpipe pressure data, depth data, block position data, flow rate data, etc. As explained, real-time data can be from one or more real-time streaming channels of equipment (e.g., one or more sensors, etc.).

As an example, a method can include predicting a future drilling-related loss event based on at least a portion of real-time data by utilizing previously received real-time data, where the previously received real-time data spans a historic period of time greater than one hour. As explained, a period of time such as an hour (e.g., or two hours to several hours, etc.) may be utilized, which may correspond to a number of samples (e.g., data samples). For example, consider a scenario where 2000 samples are utilized where the 2000 samples correspond to approximately 3 hours of data. As explained, a trained recurrent neural network model may be trained to make predictions according to a look ahead period. For example, consider a look ahead period of approximately 5 minutes or more (e.g., selected from a range of approximately 5 minutes to approximately one hour). As explained, in various examples, a 10 minute look ahead period can be implemented that affords time for taking one or more actions to address a predicted event (e.g., a prediction from a trained recurrent neural network model).

As an example, a trained recurrent neural network model can be trained utilizing historic data for a region where a wellsite is within the region and where the trained recurrent neural network model is applied to a field operation at the wellsite.

As an example, a method can include training a trained recurrent neural network where, for example, training includes one or more of oversampling loss event in historic data and under sampling no loss events in the historic data.

As an example, a method can include implementing a trained recurrent neural network for planning a well or operations for a portion of a well. For example, consider using a planning framework that can generate a digital well plan where a simulator can simulate drilling according to proposed plan instructions to generate simulation results. In such an example, the simulation results and/or the plan instructions may be input to a trained machine learning model (e.g., a trained recurrent neural network model) that can output one or more predictions as to one or more types of issues (e.g., drill loss issues, etc.). In such an example, responsive to such one or more predictions, the planning framework can revise the proposed plan instructions in a manner that can reduce risk of an issue and/or consequences of an issue. For example, consider a planning framework that can call for “loss-safe” instructions and/or performance instructions in a manner that depends on predictions from a trained machine learning model. Such an approach may provide for more performance and less “loss-safe” drilling practices, which may provide an overall more efficient plan for drilling at least a portion of a well.

As an example, a method can include one or more graphical user interfaces (GUIs) that may render information based at least in part on one or more predictions. For example, consider a GUI that renders information as to when to implement “loss-safe” practices and when to implement performance practices. As an example, where an “auto driller” framework is utilized to perform automated drilling operations, such a framework may be controlled based on predictions from one or more trained machine learning models, for example, to switch from a “loss-safe” mode to a performance mode of operation. In such an example, a “loss-safe” mode may include one or more instances of practices that call for human intervention (e.g., human in the loop (HITL) practices).

As an example, a system can include a processor; memory accessible to the processor; processor-executable instructions stored in the memory and executable by the processor to instruct the system to: receive real-time data for a field operation at a wellsite; predict a future drilling-related loss event based on at least a portion of the real-time data using a trained recurrent neural network model; and, responsive to prediction of the future drilling-related loss event, issue a signal to equipment at the wellsite.

As an example, one or more computer-readable storage media can include computer-executable instructions executable to instruct a computing system to: receive real-time data for a field operation at a wellsite; predict a future drilling-related loss event based on at least a portion of the real-time data using a trained recurrent neural network model; and, responsive to prediction of the future drilling-related loss event, issue a signal to equipment at the wellsite.

As an example, a computer program product can include executable instructions that can be executed to cause a system to operate according to one or more methods (e.g., the method 1000, the method 1600, the method 1700, etc.).

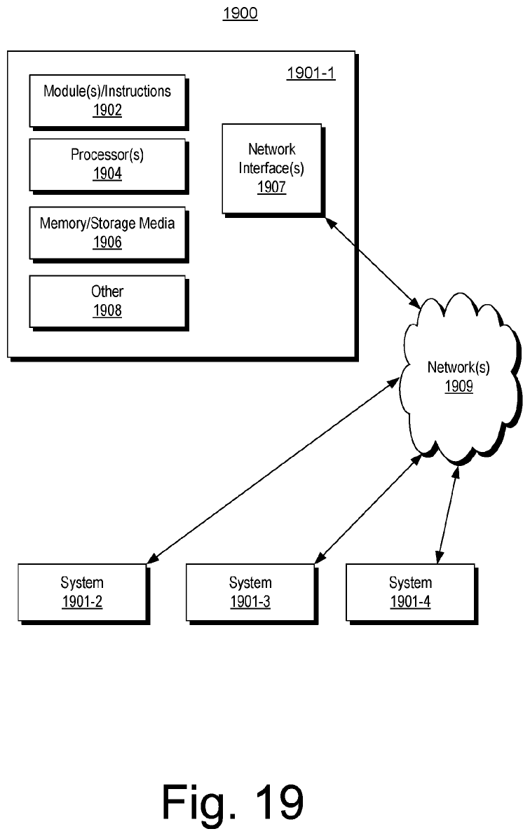

In some embodiments, a method or methods may be executed by a computing system. FIG. 19 shows an example of a system 1900 that can include one or more computing systems 1901-1, 1901-2, 1901-3 and 1901-4, which may be operatively coupled via one or more networks 1909, which may include wired and/or wireless networks.

As an example, a system can include an individual computer system or an arrangement of distributed computer systems. In the example of FIG. 19, the computer system 1901-1 can include one or more modules 1902, which may be or include processor-executable instructions, for example, executable to perform various tasks (e.g., receiving information, requesting information, processing information, simulation, outputting information, etc.).

As an example, a module may be executed independently, or in coordination with, one or more processors 1904, which is (or are) operatively coupled to one or more storage media 1906 (e.g., via wire, wirelessly, etc.). As an example, one or more of the one or more processors 1904 can be operatively coupled to at least one of one or more network interface 1907. In such an example, the computer system 1901-1 can transmit and/or receive information, for example, via the one or more networks 1909 (e.g., consider one or more of the Internet, a private network, a cellular network, a satellite network, etc.).

As an example, the computer system 1901-1 may receive from and/or transmit information to one or more other devices, which may be or include, for example, one or more of the computer systems 1901-2, etc. A device may be located in a physical location that differs from that of the computer system 1901-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1906 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

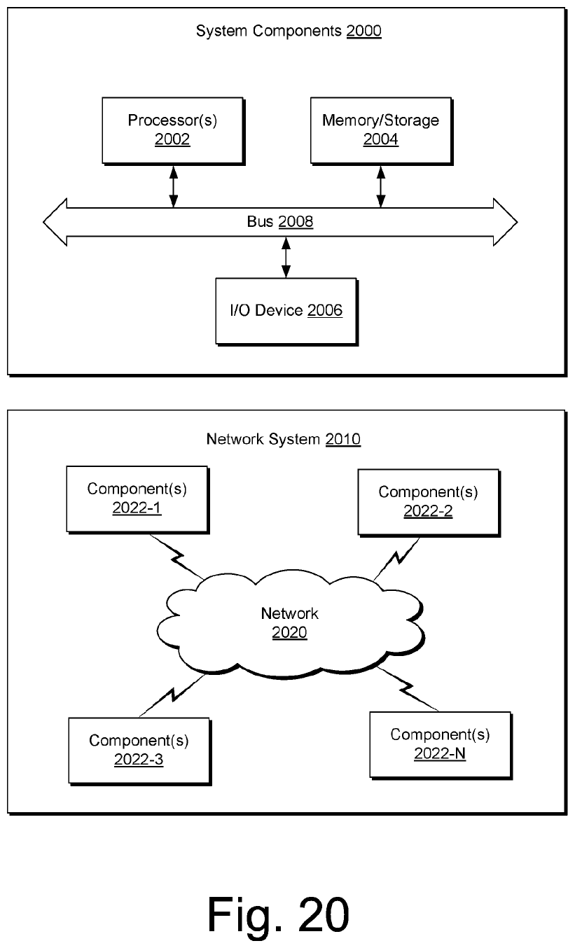

FIG. 20 shows components of a computing system 2000 and a networked system 2010 with a network 2020. The system 2000 includes one or more processors 2002, memory and/or storage components 2004, one or more input and/or output devices 2006 and a bus 2008. According to an embodiment, instructions may be stored in one or more computer-readable media (e.g., memory/storage components 2004). Such instructions may be read by one or more processors (e.g., the processor(s) 2002) via a communication bus (e.g., the bus 2008), which may be wired or wireless. The one or more processors may execute such instructions to implement (wholly or in part) one or more attributes (e.g., as part of a method). A user may view output from and interact with a process via an I/O device (e.g., the device 2006). According to an embodiment, a computer-readable medium may be a storage component such as a physical memory storage device, for example, a chip, a chip on a package, a memory card, etc.

According to an embodiment, components may be distributed, such as in the network system 2010. The network system 2010 includes components 2022-1, 2022-2, 2022-3, . . . 2022-N. For example, the components 2022-1 may include the processor(s) 2002 while the component(s) 2022-3 may include memory accessible by the processor(s) 2002. Further, the component(s) 2022-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

### DOCUMENTS INCORPORATED BY REFERENCE HEREIN

V. Shrivastava, “Predicting Market Response to Monetary Policy in Economic Crisis Phase and Deriving a Decision Support System with Artificial Neural Network,” International Journal of Trade, Economics and Finance, pp. vol. 8, no. 3, pp. 175-178, 2017.
S. Chien, R. Doyle, A. G. Davies and A. Jónsson, “The Future of AI in Space,” IEEE Intelligent Systems, vol. vol. 21, pp. 64-69, 2006.
M. Bojarski, D. D. Testa, D. Dworakowski, B. Firner, B. Flepp, P. Goyal, L. Jackel, M. Monfort, U. Muller, J. Zhang, X. Zhang, J. Zhao and K. Zieba, “End to End Learning for Self-Driving Cars,” arxiv.org, 2016.
J. M. Speers (Exxon Production Research Co.)|G. F. Gehrig (Exxon Production Research Co.), “Delta Flow: An Accurate, Reliable System for Detecting Kicks and Loss of Circulation During Drilling,” Society of Petroleum Engineers, December 1987.
J. J. Hopfield, “Artificial neural networks,” IEEE Circuits and Devices Magazine, vol. 4, pp. 3-10, Sept. 1988.

What is claimed is:

1. A method comprising:
receiving real-time data for a field operation at a wellsite;
predicting a future drilling-related loss event based on at least a portion of the real-time data using a trained recurrent neural network model; and
responsive to the predicting, issuing a signal to equipment at the wellsite.

2. The method of claim 1, wherein the trained recurrent neural network model comprises at least two successive long short-term memory components.

3. The method of claim 1, wherein the predicting comprises providing the at least a portion of the real-time data to the trained recurrent neural network model as a vector and outputting a numerical value indicative of the future drilling-related loss event.

4. The method of claim 3, comprising outputting a probability that corresponds to the numerical value indicative of the future drilling-related loss event.

5. The method of claim 1, wherein the future drilling-related loss event comprises a loss of circulation event.

6. The method of claim 1, wherein the future drilling-related loss event comprises a kick event.

7. The method of claim 1, wherein the future drilling-related loss event comprises a stuck pipe event.

8. The method of claim 1, wherein the signal comprises a reduction in energy input signal.

9. The method of claim 8, wherein the reduction in energy input signal comprises a signal to reduce rate of penetration of the field operation.

10. The method of claim 1, comprising processing the real-time data using a dimensionality reduction technique.

11. The method of claim 10, wherein the processing comprises implementing a principal component analysis (PCA) technique.

12. The method of claim 1, wherein the real-time data comprise standpipe pressure data.

13. The method of claim 1, wherein the real-time data comprise depth data.

14. The method of claim 1, wherein the real-time data comprise block position data.

15. The method of claim 1, wherein the predicting a future drilling-related loss event based on at least a portion of the real-time data comprises utilizing previously received real-time data, wherein the previously received real-time data spans a historic period of time greater than one hour.

16. The method of claim 1, wherein the trained recurrent neural network model is trained utilizing historic data for a region wherein the wellsite is within the region.

17. The method of claim 1, comprising training the trained recurrent neural network.

18. The method of claim 17, wherein the training comprises oversampling loss event in historic data and under sampling no loss events in the historic data.

19. A system comprising:
a processor;
memory accessible to the processor;
processor-executable instructions stored in the memory and executable by the processor to instruct the system to:
receive real-time data for a field operation at a wellsite;
predict a future drilling-related loss event based on at least a portion of the real-time data using a trained recurrent neural network model; and
responsive to prediction of the future drilling-related loss event, issue a signal to equipment at the wellsite.

20. One or more computer-readable storage media comprising computer-executable instructions executable to instruct a computing system to:
receive real-time data for a field operation at a wellsite;
predict a future drilling-related loss event based on at least a portion of the real-time data using a trained recurrent neural network model; and
responsive to prediction of the future drilling-related loss event, issue a signal to equipment at the wellsite.
